(19) United States
(12) Patent Application Publication
(10) Pub. No.: US 2019/0017001 A1
(43) Pub. Date: Jan. 17, 2019

(54) MULTI-COMPARTMENT DETERGENT COMPOSITIONS AND METHODS OF PRODUCTION AND USE THEREOF

(71) Applicant: Henkel IP & Holding GmbH, Duesseldorf (DE)

(72) Inventors: Casey Camire, Shelton, CT (US); Calogero A Distefano, Milford, CT (US); Troy R Graham, Ansonia, CT (US); Patrick Shane Harewood, Hamden, CT (US); Syed Humza Naqvi, Hamilton, CT (US); Edison A Ordonez, Bethany, CT (US); Daniel T Piorkowski, Fairfield, CT (US)

(73) Assignee: Henkel IP & Holding GmbH, Duesseldorf (DE)

(21) Appl. No.: 16/035,799

(22) Filed: Jul. 16, 2018

Related U.S. Application Data
(63) Continuation of application No. PCT/US2016/023459, filed on Mar. 21, 2016.

(30) Foreign Application Priority Data
Jan. 29, 2016 (US) 62289117

(51) Int. Cl. C11D 17/04; C11D 3/00; C11D 3/37

(52) U.S. Cl. CPC C11D 17/045; C11D 3/3757; C11D 3/0036

(57) ABSTRACT

The present invention is in the fields of household and industrial cleaning, particularly in applications for cleaning of dishware or laundry. The present invention provides unit dose multi-compartment detergent products comprising: a first compartment comprising a solid composition; and a second compartment comprising a liquid composition, and optionally one or more additional components. The invention also provides methods of production of such compositions, and methods of producing and using such compositions.

### BACKGROUND OF THE INVENTION

### Field of Invention

The present invention is in the fields of household and industrial cleaning, particularly in applications for cleaning laundry. The present invention provides novel unit dose multi-compartment detergent products comprising: a first compartment comprising a solid composition; and a second compartment comprising a liquid composition.

### Background Art

Unit dose detergent products are often found by consumers to be preferable for use in automatic clothes washing applications. Such unit dose products have several advantages, including convenience of use and dispensing, lower cost per use, and avoiding or minimizing skin contact with potentially irritating cleaning compositions.

Unit dose systems that can be used in automatic dishwashing applications are known in the art. For example, U.S. Pat. No. 7,439,215, discloses unit dose automatic dishwashing compositions enclosed within a multi-chambered water-soluble polymeric film pouch, with one composition (e.g., a powdered detergent composition) contained in one compartment, and a second composition (e.g., a liquid rinse aid) contained in a second compartment separate from (and sealed off from) the first compartment.

Unit dose systems which provide fabric cleaning and/or fabric softening benefits in the wash cycle of the laundering operation are also known in the art. For example, U.S. Pat. No. 5,972,870 discloses a multi-layered laundry tablet for washing which may include a detergent in the outer layer and a fabric softener, or water softener or fragrance, in the inner layer. Other known unit dose systems involve dual compartments as disclosed in International Application Publication No. WO 02/08380, where the first compartment contains a detergent composition and the second compartment contains a fabric softening composition.

Other unit-dose cleaning systems contained in multi-compartment water-soluble pouches suitable for use in dishwashing and/or fabric care are disclosed, for example, in U.S. Pat. Nos. 3,218,776; 4,776,455; 6,727,215; 6,878,679; 7,259,134; 7,282,472; 7,304,025; 7,329,441; 7,439,215; 7,464,519; and 7,595,290; the disclosures of which are incorporated herein by reference in their entireties.

The use of multi-compartment systems, such as those described above, however, has several disadvantages. First, the need to produce multiple compartment pouches in which each compartment must be sealed from the others during manufacturing increases the costs and difficulty of manufacturing unit dose products, which often in turn increases the cost of the product to the end user. Moreover, multi-compartment pouches in use are more prone to operational failure, since at least two compartments must dissolve in the aqueous wash liquor in order for the detergent compositions contained within the container to be released to perform their intended purpose of cleaning dishware or fabrics.

Another common problem observed with unit dose systems, particularly those employing a water-soluble polymeric film to produce the pouch or container, is the formulation/compatibility challenge that arises when using a water-soluble film to produce a pouch that is to hold a detergent composition that, in at least one phase, is aqueous-based. Furthermore, it is often difficult to reach composition performance targets with a more compacted formulation dose such as that used in most unit dose compositions. Finally, another challenge in producing unit dose detergent products is the issue of visual aesthetics, i.e., the need to make an attractive, self-contained dose. Making a product that performs well, has good compatibility, and also looks premium to the consumer are all challenges.

Furthermore, unit dose systems are typically formulated with low amounts of water. These low-water formulations increase the difficulty in solubilizing certain ingredients, such as anti-redeposition agents. Anti-redeposition agents prevent the migration of soils from the wash liquor onto fabric during the washing and rinsing stages of the laundry process. Commonly, unit dose liquid detergents do not contain efficacious amounts of anti-redeposition polymers because of the decreased phase stability encountered when these hydrophilic molecules are formulated into low-water formulations.

Thus, it would be advantageous to produce a multi-compartment unit dose detergent composition that has optimum performance, is economically produced, and is aesthetically pleasing to the end-user. The present invention provides such compositions, as well as methods of producing and using such compositions.

### BRIEF SUMMARY OF THE INVENTION

The present invention provides unit dose detergent products, comprising a water-soluble multi-compartment container, such as a pouch; and a cleaning system comprising at least one anti-redeposition agent, and optionally one or more additional components. The invention also provides methods of production of such compositions, and methods of use of such compositions in processes for cleaning dishware and/or fabrics, including garments, by introducing one or more of the unit dose products of the invention into an automatic washing machine suitable for washing dishware or laundry, whereby the cleaning system is released such that it comes into contact with a soiled article (e.g., dishware or fabrics) under conditions favoring the removal of one or more soils from the article.

In some embodiments, the present invention provides a unit dose laundry detergent composition comprising a multi-compartment container formed from a water-soluble polymer having at least two compartments, comprising:
a first compartment containing a solid composition; and
a second compartment containing a liquid composition, wherein the liquid composition comprises between about 8% and about 25% water; and
at least one anti-redeposition agent,
   wherein the first compartment is separate from and sealed off from the second compartment, and wherein the anti-redeposition agent is selected from the group consisting of an acrylic homopolymer and an acrylic/styrene copolymer.

In some embodiments, the water-soluble polymer comprises polyvinyl alcohol.

In some embodiments, the weight ratio of the solid composition to the liquid composition is between about 1:5 to about 1:30.

In some embodiments, the weight ratio of the solid composition to the liquid composition is between about 1:10 to about 1:16.

In some embodiments, the unit dose composition comprises three compartments. In some embodiments, the unit dose composition comprises one compartment containing a solid composition and two compartments containing a liquid composition. In some embodiments, the liquid compositions in the two compartments are different. In some embodiments, the liquid compositions in the two compartments are the same.

In some embodiments, the at least one anti-redeposition agent is an acrylic homopolymer.

In some embodiments, the solid composition comprises at least one anti-redeposition agent.

In some embodiments, the at least one anti-redeposition agent is an acrylic homopolymer having an average molecular weight of between 3,000 and 5,000. In some embodiments, the at least one anti-redeposition agent is an acrylic homopolymer having an average molecular weight of 4,500.

In some embodiments, the unit dose composition comprises at least one surfactant.

In some embodiments, the at least one anti-redeposition agent is an acrylic/styrene copolymer having an average molecular weight of between 2,000 and 4,000. In some embodiments, the at least one anti-redeposition agent is an acrylic/styrene copolymer having an average molecular weight of 3,000.

In some embodiments, the liquid composition comprises at least one surfactant. In some embodiments, the at least one surfactant in the liquid composition is selected from the group consisting of an anionic surfactant, a nonionic surfactant, a zwitterionic surfactant, an ampholytic surfactant, and a cationic surfactant.

In some embodiments, the solid composition comprises a detergency builder. In some embodiments, the detergency builder is coated with a moisture-absorbing compound. In some embodiments, the moisture-absorbing compound is sprayed onto the solid composition.

In some embodiments, the liquid composition further comprises one or more components selected from the group consisting of a detergency builder, a biocidal agent, a foam controlling agent, an enzyme, a perfume, a dye, a pH buffering agent, an anti-redeposition agent, an optical brightener, a surfactant, a water-softening agent, a bleach, a solubilizer, or a stain-removing polymer.

In some embodiments, the solid composition further comprises one or more components selected from the group consisting of a detergency builder, a biocidal agent, a foam controlling agent, an enzyme, a perfume, a dye, a pH buffering agent, an anti-redeposition agent, an optical brightener, a surfactant, a water-softening agent, a bleach, a solubilizer, or a stain-removing polymer.

In some embodiments, the unit dose composition is formulated to be suitable for use in an automatic laundering method for removing soils from fabric.

In some embodiments, the solid composition comprises an anti-redeposition agent and sodium carbonate and the liquid composition comprises a linear alkyl benzene sulfonate, a diol, an ethanolamine, and an ethoxylated alcohol.

In some embodiments, the solid composition comprises sodium citrate and the liquid composition comprises an anti-redeposition agent, a linear alkyl benzene sulfonate, a diol, an ethanolamine, and an ethoxylated alcohol.

In some embodiments, the solid composition comprises by weight between about 5% and about 20% of an anti-redeposition agent and the liquid composition comprises by weight between about 5% to about 20% of a linear alkyl benzene sulfonate, between about 5% to about 20% of a diol, between about 2% to about 10% of an ethanolamine, and between about 20% and about 25% of a ethoxylated alcohol.

In some embodiments, the liquid composition comprises by weight between about 1% to about 5% of an anti-redeposition agent, between about 5% to about 20% of a linear alkyl benzene sulfonate, between about 5% to about 20% of a diol, between about 2% to about 10% of an ethanolamine, and between about 20% and about 25% of a ethoxylated alcohol.

In some embodiments, the present invention provides a method of removing soils from soiled fabrics, comprising:
(a) placing the soiled fabrics into a chamber of an automatic fabric-laundering machine;
(b) placing at least one of the unit dose detergent compositions of the present invention into the fabric-laundering machine; and
(c) introducing water into the chamber of the fabric-laundering machine and washing the fabrics in an aqueous environment in the fabric-laundering machine under conditions favoring release of components of the unit dose detergent composition into the chamber of the fabric-laundering machine such that the components of the unit dose detergent composition contact the fabrics and remove the soils from the fabrics.

In some embodiments, the unit dose detergent composition is placed in the chamber of the fabric-laundering machine prior to introducing water into the chamber of the fabric-laundering machine.

In some embodiments, the unit dose detergent composition is placed into the chamber of the fabric-laundering machine after introducing water into the chamber of the fabric-laundering machine.

In some embodiments, the soils are selected from the group consisting of an oil-containing soil, a carbohydrate-containing soil, a protein-containing soil, a tannin-containing soil, and a particulate soil.

In some embodiments, the soils are selected from the group consisting of a pH-sensitive soil, an acid-based soil, a beverage soil, or a soil from a canned food. In some embodiments, the pH-sensitive soil is a soil from blood, grass, coffee, or tea. In some embodiments, the acid-based soil is a soil from vinegar. In some embodiments, the beverage soil is a soil from a concentrated juice, a soft drink, a sugar-sweetened drink, or a sugar-free drink. In some embodiments, the canned food soil is a soil from canned tomato juice, canned tomato soup, or canned vegetable soup.

In some embodiments, the fabric-laundering machine is a washing machine, a tergetometer, or an equivalent device.

In some embodiments, the present invention provides a method for preparing a unit dose detergent composition comprising:
(a) producing at least one solid composition and at least one liquid composition, wherein the liquid composition comprises between about 8% and about 25% water, wherein at least one of the liquid composition and the solid composition comprises at least one anti-redeposition agent, and wherein the anti-redeposition agent is selected from the group consisting of an acrylic homopolymer and an acrylic/styrene copolymer;
(b) providing a water-soluble container comprising at least two compartments;
(c) adding the at least one liquid composition to at least one compartment and the at least one solid composition to a separate compartment, wherein the at least one liquid composition and the at least one solid composition are separated by at least one partition seal;
(d) sealing the container.

In some embodiments, the water-soluble container comprises a water-soluble polymer.

In some embodiments, the water-soluble polymer comprises polyvinyl alcohol.

In some embodiments, the weight ratio of the at least one solid composition to the at least one liquid composition is between about 1:5 to about 1:30.

In some embodiments, the weight ratio of the at least one solid composition to the at least one liquid composition is between about 1:10 to about 1:16.

In some embodiments, the water-soluble container comprises three compartments. In some embodiments, the unit dose composition comprises one compartment containing a solid composition and two compartments containing a liquid composition. In some embodiments, the liquid compositions in the two compartments are different. In some embodiments, the liquid compositions in the two compartments are the same.

In some embodiments, the at least one anti-redeposition agent is an acrylic homopolymer.

In some embodiments, the solid composition comprises at least one anti-redeposition agent.

In some embodiments, the at least one anti-redeposition agent is an acrylic homopolymer having an average molecular weight of between 3,000 and 5,000. In some embodiments, the at least one anti-redeposition agent is an acrylic homopolymer having an average molecular weight of 4,500.

In some embodiments, the at least one anti-redeposition agent is an acrylic/styrene copolymer having an average molecular weight of between 2,000 and 4,000. In some embodiments, the at least one anti-redeposition agent is an acrylic/styrene copolymer having an average molecular weight of 3,000.

In some embodiments, the liquid composition further comprises at least one surfactant.

In some embodiments, the at least one surfactant is selected from the group consisting of an anionic surfactant, a nonionic surfactant, a zwitterionic surfactant, an ampholytic surfactant, and a cationic surfactant.

In some embodiments, the solid composition comprises a detergency builder.

In some embodiments, the solid composition was sprayed with a moisture-absorbing compound before adding to the compartment.

In some embodiments, the detergency builder is coated with a moisture-absorbing compound.

In some embodiments, the liquid composition further comprises one or more components selected from the group consisting of a detergency builder, a biocidal agent, a foam controlling agent, an enzyme, a perfume, a dye, a pH buffering agent, an anti-redeposition agent, an optical brightener, a surfactant, a water-softening agent, a bleach, a solubilizer, or a stain-removing polymer.

In some embodiments, the solid composition further comprises one or more components selected from the group consisting of a detergency builder, a biocidal agent, a foam controlling agent, an enzyme, a perfume, a dye, a pH buffering agent, an anti-redeposition agent, an optical brightener, a surfactant, a water-softening agent, a bleach, a solubilizer, or a stain-removing polymer.

In some embodiments, the solid composition comprises an anti-redeposition agent and sodium carbonate and the liquid composition comprises a linear alkyl benzene sulfonate, a diol, an ethanolamine, and an ethoxylated alcohol.

In some embodiments, the solid composition comprises sodium citrate and the liquid composition comprises an anti-redeposition agent, a linear alkyl benzene sulfonate, a diol, an ethanolamine, and an ethoxylated alcohol.

In some embodiments, the solid composition comprises by weight between about 5% and about 20% of an anti-redeposition agent and the liquid composition comprises by weight between about 5% to about 20% of a linear alkyl benzene sulfonate, between about 5% to about 20% of a diol, between about 2% to about 10% of an ethanolamine, and between about 20% and about 25% of a ethoxylated alcohol.

In some embodiments, the liquid composition comprises by weight between about 1% to about 5% of an anti-redeposition agent, between about 5% to about 20% of a linear alkyl benzene sulfonate, between about 5% to about 20% of a diol, between about 2% to about 10% of an ethanolamine, and between about 20% and about 25% of a ethoxylated alcohol.

In some embodiments, the unit dose detergent composition is formulated so as to be suitable for use in an automatic laundering method for removing soils from fabric.

Additional embodiments and advantages of the invention will be set forth in part in the description that follows, and will flow from the description, or may be learned by practice of the invention. The embodiments and advantages of the invention will be realized and attained by means of the elements and combinations particularly pointed out in the appended claim.

It is to be understood that both the foregoing summary and the following detailed description are exemplary and explanatory only and are not restrictive of the invention, as claimed.

### BRIEF DESCRIPTION OF THE DRAWINGS

FIGS. 1 and 2 are photographs each illustrating an exemplary multi-compartment unit dose detergent composition of the present invention.

FIG. 1 is a photograph of an exemplary unit dose multi-compartment detergent composition of the present invention in a polyvinyl alcohol (PVOH) pouch, providing a top perspective view.

FIG. 2 is a photograph of an exemplary unit dose multi-compartment detergent composition of the present invention, providing a right side view.

FIG. 3 is a graph showing the change in relative stain intensity (RSI) over time after addition of vinegar to a wash load with a formulation containing a citrate versus a formulation that does not contain a citrate. As shown in FIG. 3, the change in RSI for a formulation containing a citrate is much greater than that measured for a formulation without a citrate after addition of vinegar.

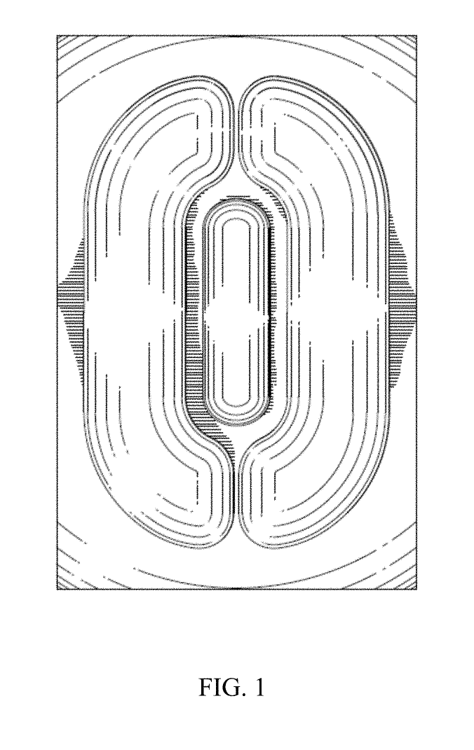

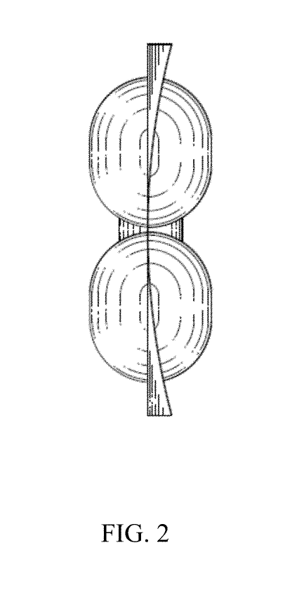

### DETAILED DESCRIPTION OF THE INVENTION

As used herein, the singular terms “a” and “the” are synonymous and used interchangeably with “one or more” and “at least one,” unless the language and/or context clearly indicates otherwise.

As used herein, the term “comprising” means including, made up of and composed of. All numbers in this description indicating amounts, ratios of materials, physical properties of materials and/or use are to be understood as modified by the word “about,” except otherwise explicitly indicated.

As used herein, the term “about” includes the recited number ±10%. Thus, “about ten” means 9 to 11.

Overview

The present invention provides unit dose detergent products, which are typically produced in the form of compositions comprising several components: a multiple-compartment container, such as a pouch, produced of a water-soluble polymer; a cleaning system comprising at least one anti-redeposition agent; and optionally, one or more additional components. In certain aspects of the invention, the compositions may comprise (a) a multiple-chamber pouch made from a water-soluble polymer, comprising at least two compartments; (b) a solid composition comprising one or more components useful in automatic laundering processes; and (c) a liquid composition comprising one or more components useful in automatic laundering processes. The present invention also provides methods of production of such compositions, and methods of use of such compositions in processes for cleaning dishware and/or fabrics, including garments, by introducing one or more of the unit dose multi-compartment products of the invention into an automatic washing machine suitable for washing dishware or laundry, whereby the cleaning system is released such that it comes into contact with a soiled article (e.g., dishware or fabrics) under conditions favoring the removal of one or more soils from the article.

The multi-compartment container can be of any form, shape, and material which is suitable to hold the compositions without allowing release of the compositions from the container prior to contact of the container with water. In some embodiments, the multi-compartment container is a pouch. In some embodiments, the multi-compartment container has the shape disclosed in U.S. Design Pat. No. D714,161, the disclosure of which is incorporated herein by reference in its entirety.

In some embodiments, the multi-compartment container comprises at least two, at least three, at least four, or at least five compartments. In some embodiments, the multi-compartment container comprises 2, 3, 4, or 5 compartments. In some embodiments, the multi-compartment container comprises 3 compartments. In some embodiments, the multi-compartment container comprises at least 2 liquid compartments and at least 1 solid compartment.

In some embodiments, the multi-compartment container comprises at least one solid composition. In some embodiments, the solid composition is a powder, granule, tablet, or combinations thereof. In some embodiments, the solid composition is a powder. In some embodiments, the multi-compartment container comprises one solid composition.

In some embodiments, the multi-compartment container comprises at least one liquid composition. In some embodiments, the liquid composition is a liquid, a structured liquid, a structured gel, or combinations thereof. In some embodiments, the liquid composition is a liquid. In some embodiments, the multi-compartment container comprises two liquid compositions.

In some embodiments, the multi-compartment container comprises two compartments—a large first compartment and a small second compartment. In some embodiments, the multi-compartment container comprises two compartments that are the same size.

In some embodiments, the multi-compartment container comprises three compartments—a large first compartment and two smaller compartments. In some embodiments, the multi-compartment container comprises three compartments—a small first compartment and two larger compartments. In some embodiments, the multi-compartment container comprises three compartments that are the same size.

In some embodiments, the multi-compartment container comprises one or more inner compartments. In some embodiments, the multi-compartment container comprises a single inner compartment. In some embodiments, the one or more inner compartments comprise one or more solid compositions. In some embodiments, the one or more inner compartments comprise one or more liquid compositions.

In some embodiments, the multi-compartment container comprises one or more outer compartments. In some embodiments, the multi-compartment container comprises a single outer compartment. In some embodiments, the one or more outer compartments comprise at least one solid composition and at least one liquid composition. In some embodiments, the one or more outer compartments comprise one or more liquid compositions. In some embodiments, the one or more outer compartments comprise different liquid compositions. In some embodiments, the one or more outer compartments comprise the same liquid composition. In some embodiments, the one or more outer compartments comprise one or more solid compositions. In some embodiments, the one or more outer compartments comprise different solid compositions. In some embodiments, the one or more outer compartments comprise the same solid composition.

In some embodiments, the multi-compartment container comprises one inner compartment and two outer compartments. In some embodiments, the one inner compartment comprises a solid composition and the two outer compartments comprise liquid compositions. In some embodiments, the two outer compartments comprise the same liquid composition.

In some embodiments, the multi-compartment container is formed from two sheets of polymeric material. In some embodiments, the compartments are thermoformed with a first lower film being heated and then held by vacuum in a mold while the inner and outer compartments are filled. In some embodiments, the one or more compartments comprising a solid composition are filled into their compartments before any compartments comprising a liquid composition are filled.

In some embodiments, the multi-compartment container is formed by a process comprising:
(a) placing a first sheet of water-soluble polymeric material over a mold having sets of compartments, each set comprising at least one inner compartment and at least one outer compartment;
(b) filling the two different parts of the detergent composition into the at least one inner and the at least one outer compartment, the parts together forming a full detergent composition; and
(c) sealing a second sheet of polymeric material to the first sheet of polymeric material to produce an at least two compartment container having at least one inner compartment and at least one outer compartment, wherein the at least two compartments are connected to each other by a continuous flat seal area.

The sealing of the first and second sheet of polymeric material can be performed using methods known to those of skill in the art. In some embodiments, the first and second sheets are sealed using heat-sealing, solvent sealing, or UV sealing. In some embodiments, the first and second sheets are sealed using water sealing.

In some embodiments, the seal area between the at least one inner compartment and the at least one outer compartment has a width of between about 1 mm to about 10 mm, between about 1 mm and about 8 mm, between about 1 mm and about 6 mm, between about 1 mm and about 4 mm, between about 1 mm and about 2 mm, between about 2 mm and about 10 mm, between about 2 mm and about 8 mm, between about 2 mm and about 6 mm, between about 2 mm and about 4 mm, between about 4 mm and about 10 mm, between about 4 mm and about 8 mm, between about 4 mm and about 6 mm, between about 6 mm and about 10 mm, between about 6 mm and about 8 mm, or between about 8 mm and about 10 mm.

In some embodiments, the shape of the one or more inner compartments comprise curved or generally straight lines. In some embodiments, the shape of the one or more inner compartments comprise curved lines. In some embodiments, the shape of the one or more outer compartments comprise curved or generally straight lines. In some embodiments, the shape of the one or more outer compartments comprise curved lines.

In some embodiments, the maximum depth of each compartment is between about 5 mm and about 40 mm, between about 5 mm and about 30 mm, between about 5 mm and about 20 mm, between about 5 mm and about 10 mm, between about 10 mm and about 40 mm, between about 10 mm and about 30 mm, between about 10 mm and about 20 mm, between about 20 mm and about 40 mm, between about 20 mm and about 30 mm, or between about 30 mm and about 40 mm. In some embodiments, the depth of the one or more outer compartments is greater than the depth of the one or more inner compartments. In some embodiments, the depth of the one or more inner compartments is greater than the depth of the one or more outer compartments. In some embodiments, the depth of the one or more outer compartments is the same as the depth of the one or more inner compartments.

In some embodiments, the total weight of the one or more solid compositions added to the one or more compartments is between about 0.5 g to about 40 g, between about 0.5 g to about 30 g, between about 0.5 g to about 20 g, between about 0.5 g to about 10 g, between about 0.5 g to about 5 g, between about 0.5 g to about 2 g, between about 0.5 g to about 1 g, between about 1 g to about 40 g, between about 1 g to about 30 g, between about 1 g to about 20 g, between about 1 g to about 10 g, between about 1 g to about 5 g, between about 1 g to about 2 g, between about 2 g to about 40 g, between about 2 g to about 30 g, between about 2 g to about 20 g, between about 2 g to about 10 g, between about 2 g to about 5 g, between about 5 g to about 40 g, between about 5 g to about 30 g, between about 5 g to about 20 g, between about 5 g to about 10 g, between about 10 g to about 40 g, between about 10 g to about 30 g, between about 10 g to about 20 g, between about 20 g to about 40 g, between about 20 g to about 30 g, or between about 30 g to about 40 g. In some embodiments, the total weight of the one or more solid compositions added to the compartments is between about 1 g to about 2 g.

In some embodiments, the total weight of the one or more liquid compositions added to the one or more compartments is between about 0.5 g to about 40 g, between about 0.5 g to about 30 g, between about 0.5 g to about 20 g, between about 0.5 g to about 10 g, between about 0.5 g to about 5 g, between about 0.5 g to about 2 g, between about 0.5 g to about 1 g, between about 1 g to about 40 g, between about 1 g to about 30 g, between about 1 g to about 20 g, between about 1 g to about 10 g, between about 1 g to about 5 g, between about 1 g to about 2 g, between about 2 g to about 40 g, between about 2 g to about 30 g, between about 2 g to about 20 g, between about 2 g to about 10 g, between about 2 g to about 5 g, between about 5 g to about 40 g, between about 5 g to about 30 g, between about 5 g to about 20 g, between about 5 g to about 10 g, between about 10 g to about 40 g, between about 10 g to about 30 g, between about 10 g to about 20 g, between about 20 g to about 40 g, between about 20 g to about 30 g, or between about 30 g to about 40 g. In some embodiments, the total weight of the one or more liquid composition added to the one or more compartments is between about 16 g to about 32 g.

In some embodiments, the ratio of volumes of the total volume of the at least one solid compartment to the total volume of the at least one liquid compartment is between about 50:1 to about 1:50, between about 40:1 to about 1:40, between about 30:1 to about 1:30, between about 26:1 to 1:26, between about 20:1 to about 1:20, between about 18:1 to about 1:18, between about 10:1 to about 1:10, or between about 5:1 to about 1:5.

In some embodiments, the weight ratio of the total weight of the at least one solid composition to the total weight of the at least one liquid composition is between about 50:1 to about 1:50, between about 40:1 to about 1:40, between about 30:1 to about 1:30, between about 26:1 to 1:26, between about 21:1 to about 1:21, between about 20:1 to about 1:20, between about 18:1 to about 1:18, between about 10:1 to about 1:10, or between about 5:1 to about 1:5. In some embodiments, the weight ratio of the at least one solid composition to the at least one liquid composition is between about 26:1 to about 1:26. In some embodiments, the weight ratio of the at least one solid composition to the at least one liquid composition is between about 21:1 to about 1:21. In some embodiments, the weight ratio of the at least one solid composition to the at least one liquid composition is between about 18:1 to about 1:18. In some embodiments, the weight ratio of the at least one solid composition to the at least one liquid composition is between about 1:5 to about 1:30. In some embodiments, the weight ratio of the at least one solid composition to the at least one liquid composition is between about 1:10 to about 1:16.

The multi-compartment container comprises at least one surfactant (also referred to herein as a detergent). Suitable classes of surfactants include those known to one of skill in the art. In some embodiments, the surfactant is an anionic surfactant, a nonionic surfactant, a zwitterionic surfactant, an ampholytic surfactant, a cationic surfactant, or combinations thereof. In some embodiments, the surfactant is in the liquid composition. In some embodiments, the surfactant is in the solid composition. In some embodiments, the surfactant is in both the liquid composition and in the solid composition.

Alkylene Sulfofatty Acid

In some embodiments, the at least one surfactant is an alkylene sulfofatty acid salt (also referred to herein as an α-sulfofatty acid ester), such as a methylester sulfonate (MES) of a fatty acid (e.g., palm oil-based MES). Such a sulfofatty acid is typically formed by esterifying a carboxylic acid with an alkanol and then sulfonating the α-position of the resulting ester. The α-sulfofatty acid ester is typically of the following formula (I):

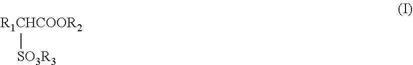

wherein R₁ is a linear or branched alkane, R₂ is a linear or branched alkane, and R₃ is hydrogen, a halogen, a mono-valent or di-valent cation, or an unsubstituted or substituted ammonium cation. R₁ can be a C₄ to C₂₄ alkane, including a C₁₀, C₁₂, C₁₄, C₁₆, and/or Cis alkane. R₂ can be a C₁ to C₈ alkane, including a methyl group. R₃ is typically a mono-valent or di-valent cation, such as a cation that forms a water soluble salt with the α-sulfofatty acid ester (e.g., an alkali metal salt such as sodium, potassium, or lithium). The α-sulfofatty acid ester of formula (I) can be a methyl ester sulfonate, such as a C₁₆ methyl ester sulfonate, a Cis methyl ester sulfonate, or a mixture thereof.

More typically, the α-sulfofatty acid ester is a salt, which is generally of the following formula (II):

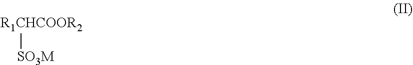

wherein R₁ and R₂ are alkanes and M is a monovalent metal. For example, R₁ can be an alkane containing 4 to 24 carbon atoms, and is typically a C₈, C₁₀, C₁₂, C₁₄, C₁₆, and/or Cis alkane. R₂ is typically an alkane containing 1 to 8 carbon atoms, and more typically a methyl group. M is typically an alkali metal, such as sodium or potassium. The α-sulfofatty acid ester of formula (II) can be a sodium methyl ester sulfonate, such as a sodium C₈-C₁₈ methyl ester sulfonate.

In one embodiment, the composition comprises at least one α-sulfofatty acid ester. For example, the α-sulfofatty acid ester can be a C₁₀, C₁₂, C₁₄, C₁₆, or C₁₈ α-sulfofatty acid ester. In another embodiment, the α-sulfofatty acid ester comprises a mixture of sulfofatty acids. For example, the composition can comprise a mixture of α-sulfofatty acid esters, such as C₁₀, C₁₂, C₁₄, C₁₆, and C₁₈ sulfofatty acids. The proportions of different chain lengths in the mixture are selected according to the properties of the α-sulfofatty acid esters. For example, C₁₆ and C₁₈ sulfofatty acids (e.g., from tallow and/or palm stearin MES) generally provide better surface active agent properties, but are less soluble in aqueous solutions. C₁₀, C₁₂, and C₁₄ α-sulfofatty acid esters (e.g., from palm kernel oil or coconut oil) are more soluble in water, but have lesser surface active agent properties. Suitable mixtures include C₈, C₁₀, C₁₂, and/or C₁₄ α-sulfofatty acid esters with C₁₆ and/or C₁₈ α-sulfofatty acid esters. For example, about 1 to about 99 weight percent of C₈, C₁₀, C₁₂, and/or C₁₄ α-sulfofatty acid ester can be combined with about 99 to about 1 weight percent of C₁₆ and/or C₁₈ α-sulfofatty acid ester. In another embodiment, the mixture comprises about 1 to about 99 weight percent of a C₁₆ or C₁₈ α-sulfofatty acid ester and about 99 to about 1 weight percent of a C₁₆ or C₁₈ α-sulfofatty acid ester. In yet another embodiment, the α-sulfofatty acid ester is a mixture of C₁₈ methyl ester sulfonate and a C₁₆ methyl ester sulfonate and having a ratio of about 2:1 to about 1:3.

The composition can also be enriched for certain α-sulfofatty acid esters, as disclosed in U.S. Pat. No. 6,683,039, the disclosure of which is incorporated by reference herein, to provide the desired surfactant properties. The disclosure of that application is incorporated by reference herein. For example, α-sulfofatty acid esters prepared from natural sources, such as palm kernel (stearin) oil, palm kernel (olein) oil, or beef tallow, are enriched for C₁₆ and/or C₁₈ α-sulfofatty acid esters by addition of the purified or semi-purified α-sulfofatty acid esters to a mixture of α-sulfofatty acid esters. Suitable ratios for enrichment range from greater than 0.5:1, about 1:1, about 1.5:1, to greater than 2:1, and up to about 5:1 or to about 6:1, or more, of C₁₆-C₁₈ to other chain length α-sulfofatty acid esters. An enriched mixture can also comprise about 50 to about 60 weight percent C₈-C₁₈ α-sulfofatty acid esters and about 40 to about 50 weight percent C₁₆ α-sulfofatty acid ester.

Methods of preparing α-sulfofatty acid esters are known to the skilled artisan. (See, e.g., U.S. Pat. Nos. 5,587,500; 5,384,422; 5,382,677; 5,329,030; 4,816,188; and 4,671,900; the disclosures of which are incorporated herein by reference.) α-Sulfofatty acid esters can be prepared from a variety of sources, including beef tallow, palm kernel oil, palm kernel (olein) oil, palm kernel (stearin) oil, coconut oil, soybean oil, canola oil, cohune oil, coco butter, palm oil, white grease, cottonseed oil, corn oil, rape seed oil, soybean oil, yellow grease, mixtures thereof, or fractions thereof. Other sources of fatty acids to make α-sulfofatty acid esters include caprylic (C₈), capric (C₁₀), lauric (C₁₂), myristic (C₁₄), myristoleic (C₁₄), palmitic (C₁₆), palmitoleic (C₁₆), stearic (C₁₈), oleic (C₁₈), linoleic (C₁₈), linolenic (C₁₈), ricinoleic (C₁₈), arachidic (C₂₀), gadolic (C₂₀), behenic (C₂₂), and erucic (C₂₂) fatty acids. α-Sulfofatty acid esters prepared from one or more of these sources are within the scope of the present invention.

The compositions according to the present invention comprise an effective amount of α-sulfofatty acid ester (i.e., an amount which exhibits the desired cleaning and surfactant properties). In one embodiment, an effective amount is at least about 0.5 weight percent α-sulfofatty acid ester. In another embodiment, the effective amount is at least about 1 weight percent α-sulfofatty acid ester. In some embodiments, the weight percent of the α-sulfofatty acid ester is between about 0.5% to about 20%, between about 0.5% to about 15%, between about 0.5% to about 10%, between about 0.5% to about 8%, between about 0.5% to about 6%, between about 0.5% to about 5%, between about 0.5% to about 4%, between about 0.5% to about 2%, between about 2% to about 20%, between about 2% to about 15%, between about 2% to about 10%, between about 2% to about 8%, between about 2% to about 6%, between about 2% to about 5%, between about 2% to about 4%, between about 4% to about 20%, between about 4% to about 15%, between about 4% to about 10%, between about 4% to about 8%, between about 4% to about 6%, between about 4% to about 5%, between about 5% to about 20%, between about 5% to about 15%, between about 5% to about 10%, between about 5% to about 8%, between about 5% to about 6%, between about 6% to about 20%, between about 6% to about 15%, between about 6% to about 10%, between about 6% to about 8%, between about 8% to about 20%, between about 8% to about 15%, between about 8% to about 10%, between about 10% to about 20%, between about 10% to about 15%, or between about 15% to about 20%.

Other surfactants suitable for use in preparing the present compositions include additional anionic surfactants, nonionic surfactants, zwitterionic surfactants, ampholytic surfactants, and cationic surfactants. Suitable nonionic surfactants include polyalkoxylated alkanolamides, which are generally of the following formula (III):

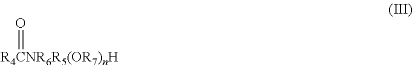

wherein R₄ is an alkane or hydroalkane, R₅ and R₇ are alkanes and n is a positive integer. R₄ is typically an alkane containing 6 to 22 carbon atoms. R₅ is typically an alkane containing 1-8 carbon atoms. R₇ is typically an alkane containing 1 to 4 carbon atoms, and more typically an ethyl group. The degree of polyalkoxylation (the molar ratio of the oxyalkyl groups per mole of alkanolamide) typically ranges from about 1 to about 100, from about 3 to about 8, or from about 5 to about 6. R₆ can be hydrogen, an alkane, a hydroalkane group, or a polyalkoxylated alkane. The polyalkoxylated alkanolamide is typically a polyalkoxylated mono- or di-alkanolamide, such as a C₁₆ and/or Cis ethoxylated monoalkanolamide, or an ethoxylated monoalkanolamide prepared from palm kernel oil or coconut oil.

Methods of manufacturing polyalkoxylated alkanolamides are known to the skilled artisan. (See, e.g., U.S. Pat. Nos. 6,034,257 and 6,034,257, the disclosures of which are incorporated by reference herein.) Sources of fatty acids for the preparation of alkanolamides include beef tallow, palm kernel (stearin or olein) oil, coconut oil, soybean oil, canola oil, cohune oil, palm oil, white grease, cottonseed oil, mixtures thereof, and fractions thereof. Other sources include caprylic (C₈), capric (C₁₀), lauric (Cu), myristic (C₁₄), myristoleic (C₁₄), palmitic (C₁₆), palmitoleic (C₁₆), stearic (C₁₈), oleic (C₁₈), linoleic (C₁₈), linolenic (C₁₈), ricinoleic (C₁₈), arachidic (C₂₀), gadolic (C₂₀), behenic (C₂₂), and erucic (C₂₂) fatty acids. Polyalkoxylated alkanolamides from one or more of these sources are within the scope of the present invention.

The compositions can comprise an effective amount of polyalkoxylated alkanolamide (e.g., an amount which exhibits the desired surfactant properties). In some applications, the composition contains about 1 to about 10 weight percent of a polyalkoxylated alkanolamide. For example, the composition can comprise at least about one weight percent of polyalkoxylated alkanolamide.

In one embodiment, the anionic surfactant is a polyethoxylated alcohol sulfate, such as those sold under the trade name CALFOAM® 303 (Pilot Chemical Company, California). Such materials, also known as alkyl ether sulfates (AES) or alkyl polyethoxylate sulfates, are those which correspond to the following formula (IV):

R′—O—(C₂H₄O)ₙ—SO₃M′ (IV)

wherein R′ is a C₈-C₂₀ alkyl group, n is from 1 to 20, and M′ is a salt-forming cation; preferably, R′ is C₁₀-C₁₈ alkyl, n is from 1 to 15, and M′ is sodium, potassium, ammonium, alkylammonium, or alkanolammonium. In another embodiment, R′ is a C₁₂-C₁₆ alkyl, n is from 1 to 6, and M′ is sodium. In another embodiment, the alkyl ether sulfate is sodium lauryl ether sulphate (SLES).

The alkyl ether sulfates will generally be used in the form of mixtures comprising varying R′ chain lengths and varying degrees of ethoxylation. Frequently such mixtures will inevitably also contain some unethoxylated alkyl sulfate materials, i.e., surfactants of the above ethoxylated alkyl sulfate formula wherein n=0. Unethoxylated alkyl sulfates may also be added separately to the liquid compositions of this invention. Suitable unalkoxylated, e.g., unethoxylated, alkyl ether sulfate surfactants are those produced by the sulfation of higher C₈-C₂₀ fatty alcohols. Conventional primary alkyl sulfate surfactants have the general formula of: ROSO₃M, wherein R is typically a linear C₈-C₂₀ hydrocarbyl group, which may be straight chain or branched chain, and M is a water-solubilizing cation; preferably R is a C₁₀-C₁₅ alkyl, and M is alkali metal. In one embodiment, R is C₁₂-C₁₄ and M is sodium. Examples of other anionic surfactants are disclosed in U.S. Pat. No. 3,976,586, the disclosure of which is incorporated by reference herein.

In one embodiment, the anionic surfactant is a water soluble salt of an alkyl benzene sulfonate having between 8 and 22 carbon atoms in the alkyl group. In one embodiment, the anionic surfactant comprises an alkali metal salt of C₁₀₋₁₆ alkyl benzene sulfonic acids, such as C₁₁₋₁₄ alkyl benzene sulfonic acids. In one embodiment, the alkyl group is linear and such linear alkyl benzene sulfonates are known in the art as “LAS.” Other suitable anionic surfactants include sodium and potassium linear, straight chain alkylbenzene sulfonates in which the average number of carbon atoms in the alkyl group is between 11 and 14. Sodium C₁₁-C₁₄, e.g., Cu, LAS is one suitable anionic surfactant for use herein. In some embodiments, the composition comprises 2-phenyl alkylbenzene sulfonate.

In some embodiments, the liquid composition comprises 2-phenyl alkylbenzene sulfonate. In some embodiments, the composition comprises by weight from about 1% to about 50%, from about 1% to about 40%, from about 1% to about 30%, from about 1% to about 25%, from about 1% to about 20%, from about 1% to about 15%, from about 1% to about 10%, from about 5% to about 50%, from about 5% to about 40%, from about 5% to about 30%, from about 5% to about 25%, from about 5% to about 20%, from about 5% to about 15%, from about 5% to about 10%, from about 10% to about 50%, from about 10% to about 40%, from about 10% to about 30%, from about 10% to about 25%, from about 10% to about 20%, from about 10% to about 15%, from about 15% to about 50%, from about 15% to about 40%, from about 15% to about 30%, from about 15% to about 25%, from about 15% to about 20%, from about 20% to about 50%, from about 20% to about 40%, from about 20% to about 30%, from about 20% to about 25%, from about 25% to about 50%, from about 25% to about 40%, from about 25% to about 30%, from about 30% to about 50%, from about 30% to about 40%, or from about 40% to about 50% of 2-phenyl sulfonic acid. In some embodiments, the liquid composition comprises by weight from about 5% to about 20% 2-phenyl alkylbenzene sulfonate.

Other suitable nonionic surfactants include those containing an organic hydrophobic group and a hydrophilic group that is a reaction product of a solubilizing group (such as a carboxylate, hydroxyl, amido, or amino group) with an alkylating agent, such as ethylene oxide, propylene oxide, or a polyhydration product thereof (such as polyethylene glycol). Such nonionic surfactants include, for example, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, and alkylamine oxides. Other suitable surfactants include those disclosed in U.S. Pat. Nos. 5,945,394 and 6,046,149, the disclosures of which are incorporated herein by reference. In another embodiment, the composition is substantially free of nonylphenol nonionic surfactants. In this context, the term “substantially free” means less than about one weight percent.

Ethoxylated Alcohol

In some embodiments, the nonionic surfactant is a ethoxylated nonionic surfactant. In some embodiments, the ethoxylated nonionic surfactant is an aliphatic primary alcohol ethoxylate. In some embodiments, the ethoxylated nonionic surfactant is an aliphatic secondary alcohol ethoxylate. In some embodiments, the alcohol ethoxylates are the condensation products of an organic aliphatic or alkyl aromatic hydrophobic compound and hydrophilic ethylene oxide groups. The length of the polyetheneoxy chain can be adjusted to achieve the desired balance between the hydrophobic and hydrophilic elements. The nonionic surfactant class includes the condensation products of a higher alcohol (e.g., an alkanol containing 8 to 16 carbon atoms in a straight or branched chain configuration) condensed with 4 to 20 moles of ethylene oxide, for example, lauryl or myristyl alcohol condensed with 16 moles of ethylene oxide (EO), tridecanol condensed with 6 to moles of EO, myristyl alcohol condensed with 10 moles of EO per mole of myristyl alcohol, the condensation product of EO with a cut of coconut fatty alcohol containing a mixture of fatty alcohols with alkyl chains varying from 10 to 14 carbon atoms in length and wherein the condensate contains either 6 moles of EO per mole of total alcohol or 9 moles of EO per mole of alcohol, and tallow alcohol ethoxylates containing 6 EO to 11 EO per mole of alcohol.

In some embodiments, the ethoxylated alcohol is a higher aliphatic, primary alcohol containing 9-15 carbon atoms, such as C₉-C₁₁ alkanol condensed with 4 to 10 moles of ethylene oxide, Cu-CD alkanol condensed with 6.5 moles ethylene oxide (for example, NEODOL 91-8 or NEODOL 9-15 (Shell Chemicals, Netherlands)), C₁₂-C₁₅ alkanol condensed with 12 moles ethylene oxide (for example, NEODOL 25-12 (Shell Chemicals, Netherlands)), C₁₄-C₁₅ alkanol condensed with 13 moles ethylene oxide (for example, NEODOL 45-13 (Shell Chemicals, Netherlands)), or a C₁₂-C₁₄ alkanol condensed with 2, 3, 4, 7, 9, or 10 moles of ethylene oxide. Ethoxylated alcohols containing 9-15 carbon atoms have an HLB (hydrophobic lipophilic balance) value of 8 to 15 and give good oil-in-water emulsification, whereas ethoxylated alcohols with HLB values below 7 contain less than 4 ethylene oxide groups and tend to be poor emulsifiers and poor detergents.

Additional satisfactory water soluble alcohol ethylene oxide condensates are the condensation products of a secondary aliphatic alcohol containing 8 to 18 carbon atoms in a straight or branched chain configuration condensed with 5 to 30 moles of ethylene oxide. Examples of commercially available nonionic detergents of the foregoing type are C₁₂-C₁₄ secondary alkanol condensed with either 9 EO (TERGITOL™ 15-S-9 (Dow Chemical Company, Michigan, United States)) or 12 EO (TERGITOL™ 15-S-12 (Dow Chemical Company, Michigan, United States)).

In some embodiments, the ethoxylated alcohol is a C₁₂-C₁₄ alkanol condensed with 7 moles of ethylene oxide. In some embodiments, the ethoxylated alcohol is a C₁₂-C₁₅ ethoxylated alcohol condensed with 7 moles of ethylene oxide. In some embodiments, the ethoxylated alcohol is NEODOL 25-7 (Shell Chemicals, Netherlands).

In some embodiments, the liquid composition comprises an ethoxylated alcohol. In some embodiments, the solid composition comprises an ethoxylated alcohol. In some embodiments, the composition comprises by weight from about 1% to about 50%, from about 1% to about 40%, from about 1% to about 30%, from about 1% to about 25%, from about 1% to about 20%, from about 1% to about 15%, from about 1% to about 10%, from about 5% to about 50%, from about 5% to about 40%, from about 5% to about 30%, from about 5% to about 25%, from about 5% to about 20%, from about 5% to about 15%, from about 5% to about 10%, from about 10% to about 50%, from about 10% to about 40%, from about 10% to about 30%, from about 10% to about 25%, from about 10% to about 20%, from about 10% to about 15%, from about 15% to about 50%, from about 15% to about 40%, from about 15% to about 30%, from about 15% to about 25%, from about 15% to about 20%, from about 20% to about 50%, from about 20% to about 40%, from about 20% to about 30%, from about 20% to about 25%, from about 25% to about 50%, from about 25% to about 40%, from about 25% to about 30%, from about 30% to about 50%, from about 30% to about 40%, or from about 40% to about 50% of an ethoxylated alcohol. In some embodiments, the liquid composition comprises by weight from about 20% to about 25% of C₁₂-C₁₅ alcohol ethoxylate 7 EO.

In some embodiments, the composition comprises a secondary anionic surfactant. Suitable secondary anionic surfactants include those surfactants that contain a long chain hydrocarbon hydrophobic group in their molecular structure and a hydrophilic group, i.e., a water solubilizing group including salts such as carboxylate, sulfonate, sulfate or phosphate groups. Suitable anionic surfactant salts include sodium, potassium, calcium, magnesium, barium, iron, ammonium, and amine salts. Other suitable secondary anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group. Examples of such anionic surfactants include water soluble salts of alkyl benzene sulfonates having between 8 and 22 carbon atoms in the alkyl group, alkyl ether sulfates having between 8 and 22 carbon atoms in the alkyl group. Other anionic surfactants include polyethoxylated alcohol sulfates, such as those sold under the trade name CALFOAM® 303 (Pilot Chemical Company, California). Examples of other anionic surfactants are disclosed in U.S. Pat. No. 3,976,586, the disclosure of which is incorporated by reference herein. In another embodiment, the composition is substantially free of additional (secondary) anionic surfactants.

In some embodiments, the composition comprises glycerin (glycerol). In some embodiments, the liquid composition comprises glycerin. In some embodiments, the composition comprises by weight from about 1% to about 50%, from about 1% to about 40%, from about 1% to about 30%, from about 1% to about 25%, from about 1% to about 20%, from about 1% to about 15%, from about 1% to about 10%, from about 5% to about 50%, from about 5% to about 40%, from about 5% to about 30%, from about 5% to about 25%, from about 5% to about 20%, from about 5% to about 15%, from about 5% to about 10%, from about 10% to about 50%, from about 10% to about 40%, from about 10% to about 30%, from about 10% to about 25%, from about 10% to about 20%, from about 10% to about 15%, from about 15% to about 50%, from about 15% to about 40%, from about 15% to about 30%, from about 15% to about 25%, from about 15% to about 20%, from about 20% to about 50%, from about 20% to about 40%, from about 20% to about 30%, from about 20% to about 25%, from about 25% to about 50%, from about 25% to about 40%, from about 25% to about 30%, from about 30% to about 50%, from about 30% to about 40%, or from about 40% to about 50% of glycerin. In some embodiments, the liquid composition comprises by weight from about 5% to about 20% glycerin. In some embodiments, the liquid composition comprises by weight from about 7% to about 16% glycerin.

Suitable zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds, such as those disclosed in U.S. Pat. No. 3,929,678, which is incorporated by reference herein.

Other suitable components include organic or inorganic detergency builders. Examples of water-soluble inorganic builders that can be used, either alone or in combination with themselves or with organic alkaline sequestrant builder salts, are glycine, alkyl, and alkenyl succinates, alkali metal carbonates, alkali metal bicarbonates, phosphates, polyphosphates, and silicates. Specific examples of such salts are sodium tripolyphosphate, sodium carbonate, potassium carbonate, sodium bicarbonate, potassium bicarbonate, sodium pyrophosphate, and potassium pyrophosphate. Examples of organic builder salts that can be used alone, or in combination with each other, or with the preceding inorganic alkaline builder salts, are alkali metal polycarboxylates, water-soluble citrates such as sodium and potassium citrate, sodium and potassium tartrate, sodium and potassium ethylenediaminetetracetate, sodium and potassium N(2-hydroxyethyl)-nitrilo triacetates, sodium and potassium N-(2-hydroxyethyl)-nitrilo diacetates, sodium and potassium oxydisuccinates, and sodium and potassium tartrate mono- and di-succinates, such as those described in U.S. Pat. No. 4,663,071, the disclosure of which is incorporated herein by reference.

Suitable biocidal agents include triclosan (5-chloro-2 (2,4-dichloro-phenoxy) phenol)), and the like. Suitable optical brighteners include stilbenes such as TINOPAL® AMS, distyrylbiphenyl derivatives such as TINOPAL® CBS-X, stilbene/naphthotriazole blends such as TINOPAL® RA-16, all sold by Ciba Geigy, oxazole derivatives, and coumarin brighteners.

Enzymes

Suitable enzymes include those known in the art, such as amylolytic, proteolytic, cellulolytic, or lipolytic type, and those listed in U.S. Pat. No. 5,958,864, the disclosure of which is incorporated herein by reference. One preferred protease, sold under the trade name SAVINASE® by Novo Nordisk Industries A/S, is a subtillase from Bacillus lentus. Other suitable enzymes include proteases, amylases, lipases and cellulases, such as ALCALASE® (bacterial protease), EVERLASE® (protein-engineered variant of SAVINASE®), ESPERASE® (bacterial protease), LIPOLASE® (fungal lipase), LIPOLASE ULTRA (protein-engineered variant of LIPOLASE), LIPOPRIME® (protein-engineered variant of LIPOLASE), TERMAMYL® (bacterial amylase), BAN (Bacterial Amylase Novo), CELLUZYME® (fungal enzyme), and CAREZYME® (monocomponent cellulase), sold by Novo Nordisk Industries A/S. In some embodiments, the enzyme is stabilized CORONASE® or CORONASE® with 0.75 4-formyl phenyl boronic acid (4-FPBA) available from Novozymes A/S (Copenhagen, Denmark). Also suitable for use in the compositions of the present invention are blends of two or more of these enzymes which are produced by many of these manufacturers, for example a protease/lipase blend, a protease/amylase blend, a protease/amylase/lipase blend, and the like. In some embodiments, the enzyme is an amylase such as STAINZYME® from Novozymes A/S (Copenhagen, Denmark). In some embodiments, the enzyme is an amylase such as PREFERENZ™ from DuPont (Wilmington, Del.).

Suitable foam controlling agents include a polyalkoxylated alkanolamide, amide, amine oxide, betaine, sultaine, C₈-C₁₈ fatty alcohols, and those disclosed in U.S. Pat. No. 5,616,781, the disclosure of which is incorporated by reference herein. Foam controlling agents are used, for example, in amounts of about 1 to about 20, typically about 3 to about 5 percent by weight. The composition can further include an auxiliary foam controlling surfactant, such as a fatty acid amide surfactant. Suitable fatty acid amides are C₈-C₂₀ alkanol amides, monoethanolamides, diethanolamides, and isopropanolamides.

In some embodiments, the composition comprises coconut oil fatty acid as a foam suppressing agent. In some embodiments, the liquid composition comprises coconut oil fatty acid. In some embodiments, the composition comprises by weight from about 1% to about 50%, from about 1% to about 40%, from about 1% to about 30%, from about 1% to about 25%, from about 1% to about 20%, from about 1% to about 15%, from about 1% to about 10%, from about 5% to about 50%, from about 5% to about 40%, from about 5% to about 30%, from about 5% to about 25%, from about 5% to about 20%, from about 5% to about 15%, from about 5% to about 10%, from about 10% to about 50%, from about 10% to about 40%, from about 10% to about 30%, from about 10% to about 25%, from about 10% to about 20%, from about 10% to about 15%, from about 15% to about 50%, from about 15% to about 40%, from about 15% to about 30%, from about 15% to about 25%, from about 15% to about 20%, from about 20% to about 50%, from about 20% to about 40%, from about 20% to about 30%, from about 20% to about 25%, from about 25% to about 50%, from about 25% to about 40%, from about 25% to about 30%, from about 30% to about 50%, from about 30% to about 40%, or from about 40% to about 50% of coconut oil fatty acid. In some embodiments, the liquid composition comprises by weight from about 0% to about 15% coconut oil fatty acid.

Ethanolamine

Ethanolamines are used in liquid laundry detergents because they impart a reserve alkalinity to the laundry bath, which is essential for efficient cleaning. They also neutralize fatty acids present in the oily soap components and convert them into amine soaps—aiding in the overall cleaning process. In some embodiments, the ethanolamine is a monoethanolamine, a diethanolamine, a triethanolamine, or combinations thereof. In some embodiments, the ethanolamine is a monoethanolamine.

In some embodiments, the liquid composition comprises an ethanolamine. In some embodiments, the solid composition comprises an ethanolamine. In some embodiments, the composition comprises by weight from about 0.5% to about 30%, from about 0.5% to about 20%, from about 0.5% to about 10%, from about 0.5% to about 8%, from about 0.5% to about 6%, from about 0.5% to about 4%, from about 0.5% to about 2%, from about 0.5% to about 1%, from about 1% to about 30%, from about 1% to about 20%, from about 1% to about 10%, from about 1% to about 8%, from about 1% to about 6%, from about 1% to about 4%, from about 1% to about 2%, from about 2% to about 30%, from about 2% to about 20%, from about 2% to about 10%, from about 2% to about 8%, from about 2% to about 6%, from about 2% to about 4%, from about 4% to about 30%, from about 4% to about 20%, from about 4% to about 10%, from about 4% to about 8%, from about 4% to about 6%, from about 6% to about 30%, from about 6% to about 20%, from about 6% to about 10%, from about 6% to about 8%, from about 8% to about 30%, from about 8% to about 20%, from about 8% to about 10%, from about 10% to about 30%, from about 10% to about 20%, or from about 20% to about 30% of an ethanolamine. In some embodiments, the composition comprises by weight from about 0.5% to about 10% of monoethanolamine. In some embodiments, the liquid composition comprises by weight from about 3% to about 6% of monoethanolamine.

Suitable liquid carriers include water, a mixture of water and a C₁-C₄ monohydric alcohol (e.g., ethanol, propanol, isopropanol, butanol, and mixtures thereof), and the like. In one embodiment, a liquid carrier comprises from about 90% to about 25% by weight, typically about 80% to about 50% by weight, more typically about 70% to about 60% by weight of the composition. Other suitable components include diluents, dyes, and perfumes. Diluents can be inorganic salts, such as sodium and potassium sulfate, ammonium chloride, sodium and potassium chloride, sodium bicarbonate, and the like. Such diluents are typically present at levels of from about 1% to about 10%, preferably from about 2% to about 5% by weight.

Humectant

A humectant, for purposes of the present invention, is a substance that exhibits high affinity for water, especially attracting water for moisturization and solubilization purposes. The water is absorbed into the humectant; not merely adsorbed at a surface layer. The water absorbed by the humectant is available to the system; it is not too tightly bound to the humectant. For example, in a skin lotion, the humectant attracts moisture from the surrounding atmosphere while reducing transepidermal water loss, and makes the water available to the skin barrier. Similarly, the humectant in a single dose liquid formula will not trap all the water needed for solubilization of other formula components—it will help to maintain the water balance between the formula, the film, and the atmosphere. These humectants possess hydrophilic groups which form hydrogen bonds with water. Common hydrophilic groups include hydroxyl, carboxyl, ester, and amine functionalities. A humectant can thus act as a solubilizer and moisture regulator in a unit dose formulation. Useful humectants include but not limited to polyols.

The polyol (or polyhydric alcohol) may be a linear or branched alcohol with two or more hydroxyl groups. Thus, diols with two hydroxyl groups attached to separate carbon atoms in an aliphatic chain may also be used. The polyol typically includes less than 9 carbon atoms, such as 9, 8, 7, 6, 5, 4, 3, or 2 carbon atoms. Preferably, the polyol includes 3 to 8 carbon atoms. More preferably, the polyol includes 3 to 6 carbon atoms. The molecular weight is typically less than 500 g/mol, such as less than 400 g/mol or less than 300 g/mol.

Examples of suitable polyols include, but not limited to, ethylene glycol, propylene glycol, butylene glycol, pentylene glycol, hexylene glycol, heptylene glycol, octylene glycol, 2-methyl-1,3-propanediol, xylitol, sorbitol, mannitol, diethylene glycol, triethylene glycol, glycerol, erythritol, dulcitol, inositol, and adonitol.

In some embodiments, the solid composition comprises at least one humectant. In some embodiments, the liquid composition comprises at least one humectant. In some embodiments, the humectant is propylene glycol, hexylene glycol, dipropylene glycol, methylpropylene glycol, or combinations thereof. In some embodiments, the liquid composition comprises by weight from about 0% to about 50%, from about 0% to about 30%, from about 0% to about 25%, from about 0% to about 20%, from about 0% to about 15%, from about 0% to about 10%, from about 0% to about 8%, from about 0% to about 6%, from about 0% to about 5%, from about 0% to about 4%, from about 0% to about 1%, from about 1% to about 50%, from about 1% to about 30%, from about 1% to about 25%, from about 1% to about 20%, from about 1% to about 15%, from about 1% to about 10%, from about 1% to about 8%, from about 1% to about 6%, from about 1% to about 5%, from about 1% to about 4%, from about 4% to about 50%, from about 4% to about 30%, from about 4% to about 25%, from about 4% to about 20%, from about 4% to about 15%, from about 4% to about 10%, from about 4% to about 8%, from about 4% to about 6%, from about 4% to about 5%, from about 5% to about 50%, from about 5% to about 30%, from about 5% to about 25%, from about 5% to about 20%, from about 5% to about 15%, from about 5% to about 10%, from about 5% to about 8%, from about 5% to about 6%, from about 6% to about 50%, from about 6% to about 30%, from about 6% to about 25%, from about 6% to about 20%, from about 6% to about 15%, from about 6% to about 10%, from about 6% to about 8%, from about 8% to about 50%, from about 8% to about 30%, from about 8% to about 25%, from about 8% to about 20%, from about 8% to about 15%, from about 8% to about 10%, from about 10% to about 50%, from about 10% to about 30%, from about 10% to about 25%, from about 10% to about 20%, from about 10% to about 15%, from about 15% to about 50%, from about 15% to about 30%, from about 15% to about 25%, from about 15% to about 20%, from about 20% to about 50%, from about 20% to about 30%, from about 20% to about 25%, from about 25% to about 50%, from about 25% to about 30%, or from about 30% to about 50% of a humectant. In some embodiments, the liquid composition comprises polyethylene glycol. In some embodiments, the liquid composition comprises from about 1% to about 20% propylene glycol. In some embodiments, the liquid composition comprises from about 0% to about 15% propylene glycol.

Anti-Redeposition Agent

The unit dose comprises at least one anti-redeposition agent. In some embodiments, the unit dose comprises 1, 2, 3, 4, or 5 anti-redeposition agents.

In some embodiments, at least one liquid composition comprises at least one anti-redeposition agent. In some embodiments, at least one solid composition comprises at least one anti-redeposition agent. In some embodiments, at least one solid composition and at least one liquid composition comprise at least one anti-redeposition agent. In some embodiments, the at least one solid composition and the at least one liquid composition comprise different anti-redeposition agents. In some embodiments, the at least one solid composition and the at least one liquid composition comprise the same anti-redeposition agent.

In some embodiments, the anti-redeposition agent is an anti-redeposition polymer. In some embodiments, the anti-redeposition agent is an acrylic acid polymer, an acrylic acid/maleic acid copolymer, an acrylic acid/methacrylic acid copolymer, or a carboxylate polyelectrolyte copolymer. In some embodiment, the anti-redeposition agent is an acrylic polymer selected from SOKALAN® PA 30, SOKALAN® PA 20, SOKALAN® PA 15, and SOKALAN® CP 10 (BASF GmbH, Germany), ACUSOL® 445G and ACUSOL® 445N (Dow Chemical Company, Midland, Mich.), and BASF ES9302 and BASF ES9303 (BASF, GmbH, Germany). In some embodiments, the anti-redeposition agent is an acrylic acid/maleic acid copolymer selected from ACUSOL® 460N and ACUSOL® 505N (Dow Chemical Company, Midland, Mich.) and SOKALAN® CP 5, SOKALAN® CP 45, and SOKALAN® CP 7 (BASF GmbH, Germany). In some embodiments, the anti-redeposition agent is an acrylic/methacrylic copolymer. In some embodiments, the anti-redeposition agent is an anionic polymer selected from ALCOSPERSE® 725, ALCOSPERSE® 726, and ALCOSPERSE® 747 (AkzoNobel, Chattanooga, Tenn.) and ACUSOL® 480N (Dow Chemical Company, Midland, Mich.). In some embodiments, the anti-redeposition agent is ACUSOL® 445G (Dow Chemical Company, Midland, Mich.). In some embodiments, the anti-redeposition agent is ACUSOL® 445N (Dow Chemical Company, Midland, Mich.). In some embodiments, the anti-redeposition agent is ALCOSPERSE® 747. In some embodiments, the anti-redeposition agent is DEQUEST SPE 1202 (Italmatch, Genova, Italy).

In some embodiments, the anti-redeposition agent is an acrylic homopolymer having an average molecular weight between 3,000 and 6,000. In some embodiments, the anti-redeposition agent is an acrylic homopolymer having an average molecular weight between 3,000 and 6,000, between 3,000 and 5,000, between 3,000 and 4,500, between 3,000 and 4,000, between 4,000 and 6,000, between 4,000 and 5,000, between 4,000 and 4,500, between 4,500 and 6,000, between 4,500 and 5,000, or between 5,000 and 6,000. In some embodiments, the anti-redeposition agent is an acrylic homopolymer having an average molecular weight of about 4,500.

In some embodiments, the anti-redeposition agent is a copolymer comprising a hydrophobic polymer and a hydrophilic polymer. In some embodiments, the hydrophobic polymer in the copolymer is an acrylic acid, an amide, an imide, an ester, an ether, an olefin, a styrene, a vinyl acetal, a vinyl, a vinylidene chloride, a vinyl ester, a vinyl ether, a vinyl pyridine, or a vinyl pyrrolidone. In some embodiments, the hydrophilic polymer in the copolymer is an acrylic acid, an acrylamide, a maleic anhydride, an allyl amine, an ethylene imine, an oxazoline, an N-isopropyl acrylamide, a methyl acrylate, an ethylene glycol, an ethylene oxide, a vinyl alcohol, or a vinyl pyrrolidone.

In some embodiments, the anti-redeposition agent is an acrylic/styrene copolymer having an average molecular weight between 1,500 and 6,000. In some embodiments, the anti-redeposition agent is an acrylic/styrene copolymer having an average molecular weight of between 1,500 and 6,000, between 1,500 and 5,000, between 1,500 and 4,000, between 1,500 and 3,000, between 1,500 and 2,000, between 2,000 and 6,000, between 2,000 and 5,000, between 2,000 and 4,000, between 2,000 and 3,000, between 3,000 and 6,000, between 3,000 and 5,000, between 3,000 and 4,000, between 4,000 and 6,000, between 4,000 and 5,000, or between 5,000 and 6,000. In some embodiments, the anti-redeposition agent is an acrylic/styrene copolymer having an average molecular weight of about 3,000.

In some embodiments, the anti-redeposition agent is an acrylic/styrene copolymer, wherein the copolymer comprises between 1 and 95 parts acrylic acid and between 5 and 99 parts styrene. In some embodiments, the anti-redeposition agent is an acrylic/styrene copolymer, wherein the ratio of acrylic acid to styrene is between 20:80 and 95:5. In some embodiments, the anti-redeposition agent is an acrylic/styrene copolymer, wherein the ratio of acrylic acid to styrene is between 1:1 and 1:10, between 1:1 and 1:8, between 1:1 and 1:6, between 1:1 and 1:4, between 1:1 and 1:2, between 1:2 and 1:10, between 1:2 and 1:8, between 1:2 and 1:6, between 1:2 and 1:4, between 1:4 and 1:10, between 1:4 and 1:8, between 1:4 and 1:6, between 1:6 and 1:10, between 1:6 and 1:8, or between 1:8 and 1:10.

In some embodiments, the solid composition comprises an anti-redeposition agent. In some embodiments, the liquid composition comprises an anti-redeposition agent. In some embodiments, the solid composition comprises by weight between about 0.1% to about 20%, between about 0.1% to about 15%, between about 0.1% to about 10%, between about 0.1% to about 8%, between about 0.1% to about 6%, between about 0.1% to about 5%, between about 0.1% to about 4%, between about 0.1% to about 2%, between about 0.5% to about 20%, between about 0.5% to about 15%, between about 0.5% to about 10%, between about 0.5% to about 8%, between about 0.5% to about 6%, between about 0.5% to about 5%, between about 0.5% to about 4%, between about 0.5% to about 2%, between about 2% to about 20%, between about 2% to about 15%, between about 2% to about 10%, between about 2% to about 8%, between about 2% to about 6%, between about 2% to about 5%, between about 2% to about 4%, between about 4% to about 20%, between about 4% to about 15%, between about 4% to about 10%, between about 4% to about 8%, between about 4% to about 6%, between about 4% to about 5%, between about 5% to about 20%, between about 5% to about 15%, between about 5% to about 10%, between about 5% to about 8%, between about 5% to about 6%, between about 6% to about 20%, between about 6% to about 15%, between about 6% to about 10%, between about 6% to about 8%, between about 8% to about 20%, between about 8% to about 15%, between about 8% to about 10%, between about 10% to about 20%, between about 10% to about 15%, or between about 15% to about 20% of an anti-redeposition agent. In some embodiments, the liquid composition comprises by weight between about 0.5% to about 20%, between about 0.5% to about 15%, between about 0.5% to about 10%, between about 0.5% to about 8%, between about 0.5% to about 6%, between about 0.5% to about 5%, between about 0.5% to about 4%, between about 0.5% to about 2%, between about 2% to about 20%, between about 2% to about 15%, between about 2% to about 10%, between about 2% to about 8%, between about 2% to about 6%, between about 2% to about 5%, between about 2% to about 4%, between about 4% to about 20%, between about 4% to about 15%, between about 4% to about 10%, between about 4% to about 8%, between about 4% to about 6%, between about 4% to about 5%, between about 5% to about 20%, between about 5% to about 15%, between about 5% to about 10%, between about 5% to about 8%, between about 5% to about 6%, between about 6% to about 20%, between about 6% to about 15%, between about 6% to about 10%, between about 6% to about 8%, between about 8% to about 20%, between about 8% to about 15%, between about 8% to about 10%, between about 10% to about 20%, between about 10% to about 15%, or between about 15% to about 20% of an anti-redeposition agent. In some embodiments, the weight percent in the liquid composition of the anti-redeposition agent is between about 0% to about 3%. In some embodiments, the weight percent in the solid composition of the anti-redeposition agent is between about 1% to about 20%.

In some embodiments, the anti-redeposition agent in the liquid composition is selected from SOKALAN® PA 30 (BASF GmbH, Germany), ACUSOL® 445G (Dow Chemical Company, Midland, Mich.), ACUSOL® 445N (Dow Chemical Company, Midland, Mich.), BASF ES9302 (BASF, GmbH, Germany), BASF ES9303 (BASF, GmbH, Germany), and ALCOSPERSE® 747 (AkzoNobel, Chattanooga, Tenn.). In some embodiments, the anti-redeposition agent in the liquid composition is ALCOSPERSE® 747 (AkzoNobel, Chattanooga, Tenn.). In some embodiments, the weight percent of ALCOSPERSE® 747 (AkzoNobel, Chattanooga, Tenn.) in the liquid composition is between about 0% to about 3%.

In some embodiments, the at least one anti-redeposition agent in the solid composition is selected from SOKALAN® PA 30 (BASF GmbH, Germany), ACUSOL® 445G (Dow Chemical Company, Midland, Mich.), ACUSOL® 445N (Dow Chemical Company, Midland, Mich.), BASF ES9302 (BASF, GmbH, Germany), BASF ES9303 (BASF, GmbH, Germany), and ALCOSPERSE® 747 (AkzoNobel, Chattanooga, Tenn.). In some embodiments, the anti-redeposition agent in the solid composition is ACUSOL® 445G (Dow Chemical Company, Midland, Mich.). In some embodiments, the weight percent of ACUSOL® 445G (Dow Chemical Company, Midland, Mich.) in the solid composition is between about 5% to about 20%.

In some embodiments, the anti-redeposition agent in the solid composition has been coated onto a powder carrier. In some embodiments, the anti-redeposition agent in the solid composition has been coated onto sodium chloride, sodium sulfate, or combinations thereof as a powder carrier.

Dyes

All dyes suitable for use in laundry compositions can be used in the present invention. In some embodiments, the solid composition comprises one or more dyes. In some embodiments, the liquid composition comprises one or more dyes. Suitable dyes include, but are not limited to chromophore types, e.g., azo, anthraquinone, triarylmethane, methine quinophthalone, azine, oxazine thiazine, which may be of any desired color, hue or shade, including those described elsewhere herein. Suitable dyes can be obtained from any major supplier such as Clariant, Ciba Speciality Chemicals, Dystar, Avecia or Bayer. In some embodiments, the dye is blue HP dye. In some embodiments, the dye is disperse violet 28 (DV28).

Perfumes

The compositions of the invention may optionally include one or more perfumes or fragrances. In some embodiments, the solid composition comprises one or more perfumes. In some embodiments, the liquid composition comprises one or more perfumes. As used herein, the term “perfume” is used in its ordinary sense to refer to and include any fragrant substance or mixture of substances including natural (obtained by extraction of flowers, herbs, leaves, roots, barks, wood, blossoms, or plants), artificial (mixture of natural oils or oil constituents), and synthetically produced odoriferous substances. Typically, perfumes are complex mixtures of blends of various organic compounds such as alcohols, aldehydes, ethers, aromatic compounds and varying amounts of essential oils (e.g., terpenes) such as from 0% to 80%, usually from 1% to 70% by weight, of the essential oils themselves being volatile odoriferous compounds and also serving to dissolve the other components of the perfume. Suitable perfume ingredients include those disclosed in “Perfume and Flavour Chemicals (Aroma Chemicals)”, published by Steffen Arctander (1969), which is incorporated herein by reference. In some embodiments, the perfume is lavender. Perfumes can be present from about 0.1% to about 10%, and preferably from about 0.5% to about 5% (weight) of the composition.

Other Optional Ingredients

The compositions may also contain one or more optional ingredients conventionally included in fabric treatment compositions such as pH buffering agents, perfume carriers, fluorescers, colorants, hydrotropes, antifoaming agents, antiredeposition agents, polyelectrolytes, enzymes, optical brightening agents, pearlescers, anti-shrinking agents, anti-wrinkle agents, anti-spotting agents, germicides, fungicides, anti-corrosion agents, drape imparting agents, anti-static agents, ironing aids crystal growth inhibitors, anti-oxidants, and anti-reducing agents. Examples and sources of suitable such components are well-known in the art and/or are described herein. In some embodiments, the compositions comprise a mannan stain removers such as MANNAWAY® (Novozymes, Copenhagen, Denmark). In some embodiments, the compositions comprise a soil-releasing polymer such as polyethylene imine ethoxylated, sold under the trade name of SOKALAN® HP 20 (BASF GmbH, Germany). In some embodiments, the compositions comprise a polyethylene terephthalate/polyoxyethylene terephthalate polyester or a polyethylene terephthalate/polyethylene glycol polyester as a soil-releasing polymer, such as those disclosed in U.S. Pat. No. 3,557,039. In some embodiments, the soil-releasing polymer is a condensation product of an aromatic dicarboxylic acid or dihydric alcohol, such as those disclosed in European Patent Application Nos. EP 185 427, EP 241 984, EP 241 985, and EP 272 033. In some embodiments, the compositions comprise a bittering agent such as denatonium benzoate, sold under the trade name of BITREX® (Johnson Matthey, London, United Kingdom).

In some embodiments, the compositions comprise sodium sulfite. In some embodiments, sodium sulfite acts as an anti-oxidant to prevent color change over time. In some embodiments, the liquid composition comprises sodium sulfite. In some embodiments, the composition comprises by weight between about 0.5% to about 20%, between about 0.5% to about 15%, between about 0.5% to about 10%, between about 0.5% to about 8%, between about 0.5% to about 6%, between about 0.5% to about 5%, between about 0.5% to about 4%, between about 0.5% to about 2%, between about 2% to about 20%, between about 2% to about 15%, between about 2% to about 10%, between about 2% to about 8%, between about 2% to about 6%, between about 2% to about 5%, between about 2% to about 4%, between about 4% to about 20%, between about 4% to about 15%, between about 4% to about 10%, between about 4% to about 8%, between about 4% to about 6%, between about 4% to about 5%, between about 5% to about 20%, between about 5% to about 15%, between about 5% to about 10%, between about 5% to about 8%, between about 5% to about 6%, between about 6% to about 20%, between about 6% to about 15%, between about 6% to about 10%, between about 6% to about 8%, between about 8% to about 20%, between about 8% to about 15%, between about 8% to about 10%, between about 10% to about 20%, between about 10% to about 15%, or between about 15% to about 20% of an anti-redeposition agent. In some embodiments, the liquid composition comprises by weight between about 0.5% to about 20%, between about 0.5% to about 15%, between about 0.5% to about 10%, between about 0.5% to about 8%, between about 0.5% to about 6%, between about 0.5% to about 5%, between about 0.5% to about 4%, between about 0.5% to about 2%, between about 2% to about 20%, between about 2% to about 15%, between about 2% to about 10%, between about 2% to about 8%, between about 2% to about 6%, between about 2% to about 5%, between about 2% to about 4%, between about 4% to about 20%, between about 4% to about 15%, between about 4% to about 10%, between about 4% to about 8%, between about 4% to about 6%, between about 4% to about 5%, between about 5% to about 20%, between about 5% to about 15%, between about 5% to about 10%, between about 5% to about 8%, between about 5% to about 6%, between about 6% to about 20%, between about 6% to about 15%, between about 6% to about 10%, between about 6% to about 8%, between about 8% to about 20%, between about 8% to about 15%, between about 8% to about 10%, between about 10% to about 20%, between about 10% to about 15%, or between about 15% to about 20% of sodium sulfite. In some embodiments, the weight percent in the liquid composition of sodium sulfite is between about 0% to about 3%.

Production of Solid Composition

The formulation of the solid compositions of the present invention may comprise soda ash (white or colored), sodium percarbonate, anionic and/or nonionic surfactants, additional fillers such as sodium sulfate, zeolite, etc. and optionally enzymes, optical brighteners, bleach activators, polymers, etc., and performance enhancers. Typical surfactants suitable for use in the compositions of the present invention include anionic surfactants, nonionic surfactants, zwitterionic surfactants, ampholytic surfactants, cationic surfactants, and the like. Suitable such surfactants are described herein and are known in the art, for example those described in Surface Active Agents, Volumes I and II by Schwartz, Perry and Berch (New York, Interscience Publishers); Nonionic Surfactants, ed. by M. J. Schick (New York, M. Dekker, 1967); and in McCutcheon's Emulsifiers & Detergents (1989 Annual, M. C. Publishing Co.); the disclosures of which are incorporated herein by reference.

In some embodiments, the solid composition comprises sodium chloride, sodium sulfate, or combinations thereof. In some embodiments, the solid composition comprises sodium chloride, sodium sulfate, or combinations thereof and at least one anti-redeposition agent.

Moisture-Absorbing Compound

It is desirable to provide moisture protection of the powder that is in close proximity to the one or more compartments comprising liquid compositions. In some embodiments, the solid composition is prepared using a moisture-absorbing compound. In some embodiments, the moisture-absorbing compound is sodium carbonate, sodium aluminosilicate, sodium sulphate, sodium citrate, or silica. In some embodiments, the moisture-absorbing compound is sodium carbonate. In some embodiments, the moisture absorbing compound is sodium citrate. The solid composition may comprise granular detergency builders such as citrates, phosphates, zeolites, or combinations thereof; with or without a moisture controlling compound or coating.

In some embodiments, the weight percent of the moisture-absorbing compound is between about 0.5% to about 20%, between about 0.5% to about 15%, between about 0.5% to about 10%, between about 0.5% to about 8%, between about 0.5% to about 6%, between about 0.5% to about 5%, between about 0.5% to about 4%, between about 0.5% to about 2%, between about 2% to about 20%, between about 2% to about 15%, between about 2% to about 10%, between about 2% to about 8%, between about 2% to about 6%, between about 2% to about 5%, between about 2% to about 4%, between about 4% to about 20%, between about 4% to about 15%, between about 4% to about 10%, between about 4% to about 8%, between about 4% to about 6%, between about 4% to about 5%, between about 5% to about 20%, between about 5% to about 15%, between about 5% to about 10%, between about 5% to about 8%, between about 5% to about 6%, between about 6% to about 20%, between about 6% to about 15%, between about 6% to about 10%, between about 6% to about 8%, between about 8% to about 20%, between about 8% to about 15%, between about 8% to about 10%, between about 10% to about 20%, between about 10% to about 15%, or between about 15% to about 20%.

In some embodiments, the powder has been formed into granules by agglomeration using a moisture-absorbing compound. As used herein, the term agglomeration means the build-up of small particles to form a granular powder.

In some embodiments, the powder is agglomerated comprising a premix of moisture-absorbing compound. In some embodiments, the powder is agglomerated comprising a premix of sodium carbonate. In some embodiments, the powder is agglomerated using a premix of sodium carbonate and a flow aid. In some embodiments, the powder is agglomerated by fine dispersion mixing or granulation of at least one liquid in the presence of an effective amount of a powder which comprises a moisture-absorbing compound.

In some embodiments, the granules are prepared by spraying some or all of the moisture-absorbing compound on the powder in a suitable mixer or rotating drum. In some embodiments, the agglomerated granules are prepared by:
(a) making a liquid system comprising at least one moisture-absorbing compound and a liquid; and
(b) spraying on a part, or all of, the liquid system of (a) onto the powder.

In some embodiments, the liquid is water.

In some embodiments, the solid composition comprises a citrate. In some embodiments, the citrate in the solid composition is sodium citrate. In some embodiments, a formulation comprising sodium citrate in the solid composition shows an improvement in removal of a pH sensitive stain (e.g., grass) in the presence of an acid-containing stain (e.g., vinegar, canned tomato, and beverage concentrates). In some embodiments, after the completion of one wash cycle, a formulation comprising citrate in the solid composition shows a change in RSI (relative stain intensity) that is between 2 and 10 times, between 2 and 8 times, between 2 and 6 times, between 2 and 4 times, between 4 and 10 times, between 4 and 8 times, between 4 and 6 times, between 6 and 10 times, between 6 and 8 times, or between 8 and 10 times greater than the change in RSI calculated for a formulation comprising no citrate in the solid composition on pH sensitive stains in the presence of an acid-containing stain.

Production of Liquid Compositions

The formulation for the liquid compositions of the present invention can contain a combination of diols, such as propylene glycol, dipropylene glycol, and methylpropylene glycol; any combination thereof and optionally other diols or triols. It also contains sodium stearate (or any stearate salt) to create structure. It also optionally contains non-ionic surfactants, polymers as anti-redeposition agents or rinse aids, fragrance, and, most preferably, a dye (or dyes) for aesthetic appeal. Other exemplary liquid compositions suitable for use in the unit doses of the present invention are described in the Examples herein. Other components suitable for use in the liquid compositions the present invention (e.g., rinse aids, bleaching agents, enzymes, catalysts for activating bleaching systems, etc.) are well-known in the art and will be familiar to those of ordinary skill.

In some embodiments, the at least one liquid composition comprises water. In some embodiments, the at least one liquid composition comprises by volume from about 1% to about 50%, from about 1% to about 40%, from about 1% to about 30%, from about 1% to about 25%, from about 1% to about 20%, from about 1% to about 15%, from about 1% to about 10%, from about 5% to about 50%, from about 5% to about 40%, from about 5% to about 30%, from about 5% to about 25%, from about 5% to about 20%, from about 5% to about 15%, from about 5% to about 10%, from about 10% to about 50%, from about 10% to about 40%, from about 10% to about 30%, from about 10% to about 25%, from about 10% to about 20%, from about 10% to about 15%, from about 15% to about 50%, from about 15% to about 40%, from about 15% to about 30%, from about 15% to about 25%, from about 15% to about 20%, from about 20% to about 50%, from about 20% to about 40%, from about 20% to about 30%, from about 20% to about 25%, from about 25% to about 50%, from about 25% to about 40%, from about 25% to about 30%, from about 30% to about 50%, from about 30% to about 40%, or from about 40% to about 50% of water. In some embodiments, the at least one liquid composition comprises by volume from about 5% to about 30% water. In some embodiments, the at least one liquid composition comprises by volume from about 8% to about 25% water.

Containers containing compartments containing liquid compositions may contain a large amount of air because it is very difficult to evacuate the air without contamination of the sealing area. Contamination of the sealing area can produce a weak seal. Therefore, it may be necessary to maintain the liquid level in the open container below the sealing area of the container causing the container to have a considerable volume occupied by air as compared with the volume occupied by the liquid. In some embodiments, the volume of the air bubble is between about 5% to about 50%, between about 5% to about 40%, between about 5% to about 30%, between about 5% to about 20%, between about 5% to about 10%, between about 10% to about 50%, between about 10% to about 40%, between about 10% to about 30%, between about 10% to about 20%, between about 20% to about 50%, between about 20% to about 40%, between about 20% to about 30%, between about 30% to about 50%, between about 30% to about 40%, or between about 40% to about 50% of the total volume of the liquid compartment.

Water-Soluble Container

The water soluble container used in the compositions of the present invention is made from a water-soluble material which dissolves, ruptures, disperses, or disintegrates upon contact with water, releasing thereby the composition or cleaning system contained within the container. In some embodiments, the multi-compartment container is made of a material is that soluble in water. In some embodiments, the material has a water-solubility of between 50% and 99%, between 50% and 90%, between 50% and 80%, between 50% and 70%, between 50% and 60%, between 60% and 99%, between 60% and 90%, between 60% and 80%, between 60% and 70%, between 70% and 99%, between 70% and 90%, between 70% and 80%, between 80% and 99%, between 80% and 90%, and between 90% and 99%.

In some embodiments, the multi-chamber or multi-compartment sealed water soluble container, which may be in the form of a pouch, is formed from a water soluble polymer. Non-limiting examples of suitable such water soluble polymers include polyvinyl alcohol, cellulose ethers, polyethylene oxide, starch, polyvinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resins, polyethyleneimine, ethyl hydroxyethylcellulose, ethyl methylcellulose, hydroxyethyl methylcellulose, and mixtures thereof. In some embodiments, the water soluble container is made from a lower molecular weight water-soluble polyvinyl alcohol film-forming resin.

Preferred water soluble polymers for forming the pouch are polyvinyl alcohol (PVOH) resins sold under trade name MONOSOL® (MonoSol LLC, Indiana). In some embodiments, the grade is MONOSOL® film having a weight average molecular weight range of about 55,000 to 65,000 and a number average molecular weight range of about 27,000 to 33,000. In some embodiments, the film material will have a thickness of approximately 3 mil or 75 micrometers. Alternatively, commercial grade PVOH films are suitable for use in the present invention, such as those that are commercially available from Monosol (Merrillville, Ind.) (e.g., MONOSOL® film M8630) or from Aicello (Aiichi, Japan; North American subsidiary in North Vancouver, BC, Canada) (e.g., Aicello fil PT75).

In some embodiments, the water soluble container further comprises a cross-linking agent. In some embodiments, the cross-linking agent is selected from the group consisting of formaldehyde, polyesters, epoxides, isocyanates, vinyl esters, urethanes, polyimides, acrylics with hydroxyl, carboxylic, isocyanate or activated ester groups, bis(methacryloxypropyl)tetramethylsiloxane (styrenes, methylmetacrylates), n-diazopyruvates, phenylboronic acids, cis-platin, divinylbenzene (styrenes, double bonds), polyamides, dialdehydes, triallyl cyanurates, N-(2-ethanesulfonylethyl)pyridinium halides, tetraalkyltitanates, titanates, borates, zirconates, or mixtures thereof. In some embodiments, the cross-linking agent is boric acid or sodium borate.

In some embodiments, the water-soluble container or film from which it is made can contain one or more additional components, agents or features, such as one or more perfumes or fragrances, one or more enzymes, one or more surfactants, one or more rinse agents, one or more dyes, one or more functional or aesthetic particles, and the like. Such components, agents, or features can be incorporated into or on the film when it is manufactured, or are conveniently introduced onto the film during the process of manufacturing the cleaning compositions of the present invention, using methods that are known in the film-producing arts.

In some embodiments, the water soluble container comprises a protective layer between the film polymer and the composition in the pouch. In some embodiments, the protective layer comprises polytetrafluoroethylene (PTFE).

Production of Unit Dose Compositions

The multi-compartment, water-soluble container (e.g., pouch) used in the present compositions may be in any desirable shape and size and may be prepared in any suitable way, such as via molding, casting, extruding or blowing, and is then filled using an automated filling process. Examples of processes for producing and filling water-soluble containers, suitable for use in accordance with the present invention, are described in U.S. Pat. Nos. 3,218,776; 3,453,779; 4,776,455; 5,699,653; 5,722,217; 6,037,319; 6,727,215; 6,878,679; 7,259,134; 7,282,472; 7,304,025; 7,329,441; 7,439,215; 7,464,519; and 7,595,290; the disclosures of all of which are incorporated herein by reference in their entireties. In some embodiments, the pouches are filled using the cavity filling approach described in U.S. Pat. Nos. 3,218,776 and 4,776,455; machinery necessary for carrying out this process is commercially available, e.g., from Cloud Packaging Solutions (Des Plaines, Ill.; a division of Ryt-way Industries, LLC, Lakeville, Minn.).

Uses

The present invention also provides methods of removing soils from soiled dishware or soiled fabrics.

In some embodiments, the invention provides a method of removing soils from soiled fabrics, comprising: (a) placing said soiled fabrics into the chamber of an automatic fabric-laundering machine, which may be, for example, a washing machine or a tergetometer, or an equivalent device; (b) placing at least one of the multi-compartment unit dose compositions of the invention into said fabric-washing machine; and (c) introducing water into the chamber of said machine and washing said fabrics in an aqueous environment in said machine under conditions favoring the release of the cleaning system into the chamber of said machine such that the components of said cleaning system contact said fabrics and remove said soils from said fabrics.

In some embodiments, the multi-compartment unit dose composition is placed into the chamber of said fabric-washing machine prior to introducing water into the chamber of said machine. In another such aspect, the multi-compartment unit dose composition is placed into the chamber of said fabric-washing machine after introducing water into the chamber of said machine.

Soils that are suitably removed from dishware or fabrics using the compositions and methods of the present invention include, but are not limited to, oil-containing soils, carbohydrate-containing soils, protein-containing soils, tannin-containing soils, and particulate soils.

The following examples are illustrative and non-limiting, of the device, products and methods of the present invention. Suitable modifications and adaptations of the variety of conditions, formulations and other parameters normally encountered in the field and which are obvious to those skilled in the art in view of this disclosure are within the spirit and scope of the invention.

### EXAMPLES

### Example 1: Multi-Compartment Unit Dose Laundry Detergent

Exemplary multi-compartment unit dose laundry detergent compositions of the present invention were prepared by combining the listed materials in the listed proportions (% by weight).

All of the exemplified liquid compositions were packed into compartments of the unit dose composition, each compartment containing between about 20 to about 30 mL of liquid. The film used to make the unit dose composition was a commercially available film MONOSOL® 8310 (Monosol, Inc., Merrillville, Ind.) or SOLUBON® GA (Aicello, Princeton, N.J.). The process for manufacturing the unit dose detergent compositions is known in the art.

To produce the liquid composition, C₁₂-C₁₅ alcohol ethoxylate was added to a mixer and stirred at 100 rpm. To the mixer was added propylene glycol, glycerin, monoethanolamine, deionized water, and an optical brightener. The mixing speed was increased to 200 rpm. The linear alkyl benzene sulfonate was slowly added to the mixer followed by the slow addition of coconut oil fatty acid. The temperature increased and was allowed to cool to below 110° F. The alkyl ether sulfate was slowly added to the mixer followed by SOKALAN® HP20 and BITREX®. The temperature increased after addition and was allowed to cool to below 100° F. The enzymes (protease, mannanase, and amylase) were added to the mixer followed by the addition of fragrances and dyes. Additional deionized water was added as needed. Viscosity measurements and pH measurements were taken as need for each batch.

To produce the solid composition, sodium carbonate was added to a mixer followed by the addition of the acrylic polymer. The composition was mixed for five minutes. In a separate container, water and sodium carbonate were mixed and poured into a pressurized vessel. The mixer was turned on for fifteen minutes followed by spraying the contents of the pressurized vessel into the mixer until the liquid ran out. The batch was allowed to cool to 80° F. ZeoFree® was added to the mixer followed by mixing for five minutes. The mixture was poured into a drum. In the drum, the mixture was screened with a 14 standard mesh followed by a 16 standard mesh. Bulk density measurement and particle size distribution were taken as needed for each batch.

Unit dose detergent compositions were prepared by filling two outer compartments with the liquid composition disclosed in TABLE 1 and one inner compartment with the solid composition disclosed in TABLE 2. Detergent compositions are as follows:

TABLE 1
Liquid Composition (calculated total water of 14.2%).

| Component | Activity % | Amount (%) |
|---|---|---|
| C₁₂-C₁₅ alcohol ethoxylate 7EO | 100 | 25.0 |
| propylene glycol | 100 | 10.6 |
| glycerin | 99 | 6.3 |
| monoethanolamine | 99 | 3.4 |
| deionized water (added as 100% water) | 100 | 4.0 |
| sodium sulfite solution | 100 | 0.3 |
| dye | 96 | 5.0 |
| linear alkyl benzene sulfonic acid (LAS) | 100 | 10.0 |
| coconut oil fatty acid | 60 | 26.0 |
| alkyl ether sulfate (AES) | 80 | 2.5 |
| BITREX ® | 15 | 2.0 |
| soil-releasing polymer | 25 | 0.1 |
| protease | 52 | 2.5 |
| mannase | 46 | 0.6 |
| amylase | 61 | 0.4 |
| fragrance + color | 100 | 1.5 |
| Total | | 100.0 |

TABLE 2
Solid Composition.

| | Weight (lbs) | Weight % |
|---|---|---|
| Dry Powder | | |
| Soda ash | 75 | 74.26 |
| Anti-redeposition agent (ACUSOL ® 445G) | 15 | 14.85 |
| ZEOFREE ® | 1 | 0.99 |
| Liquid for spray coating | | |
| Water | 7.5 | 7.43 |
| Soda ash | 2.5 | 2.48 |
| Total | 101 | 100.00 |

In addition to anti-redeposition agents, the dry powder includes a basic ingredient (soda ash (i.e., sodium carbonate)) that increases the pH of the wash liquor and an absorbent processing aid (i.e., ZEOFREE®, Huber Engineered Materials, Bauxite, Ark.) that helps to maintain the flowability of the powder. Polycarboxylate anti-redeposition agents such as ACUSOL® 445G (Dow Chemical Company, Midland, Mich.) are hygroscopic which lead to absorption of moisture by the powder in the chamber especially in such proximity to the water-containing liquid compositions. The moisture protection of the powder containing an anti-redeposition agent in close proximity to one or more compartments comprising liquid compositions is another key feature of the present invention. Moisture protection is achieved in this example by spray coating a powder comprising soda ash (sodium carbonate), an anti-redeposition agent, and an absorbent flow aid with an aqueous solution of soda ash and agglomerating the entire mixture followed by drying to yield a flowable moisture-resistant, soluble powder.

### Example 2: Performance of Multi-Compartment Detergent Compositions

To illustrate the performance of the formulations of the invention, a five wash cycle test was performed to compare a leading competitive unit-dose laundry detergent (Benchmark laundry detergent package) with a multi-compartment unit dose of the invention. The anti-redeposition benefit was measured by the stain removal index (SRI)—a larger SRI indicates greater prevention of soil redeposition. The SRI was measured on cotton after wash cycles 1, 3, and 5. The multi-compartment unit dose contained two compartments on the outer section of the unit dose comprising the liquid composition of TABLE 1 and one compartment on the inner section of the unit dose comprising the solid composition of TABLE 2. The weight ratio of total liquid composition to the total solid composition of the unit dose was about 13:1.

TABLE 3 provides a comparison of the amount of anti-redeposition agent for the formulation of the invention versus SRI value after 5 wash cycles. As shown in TABLE 3, the multi-chamber unit doses of the invention gave a higher SRI than the competitive unit-dose laundry detergent. The inclusion of 0.26 g ACUSOL® 445G (Dow Chemical Company, Midland, Mich.) in the agglomerated powder composition provided a SRI of 96.2 versus the SRI found for the Benchmark laundry detergent package of 86.1. Larger SRI values were observed after the first wash cycle with the performance gap increasing over the course of the 5 wash cycles.

TABLE 3
SRI values for multi-compartment unit
dose and competitive product.

| | Anti-redeposition | Anti-redeposition | |
|---|---|---|---|
| | agent in liquid | agent in powder | SRI |
| Formulation | chamber (g) | chamber (g) | value |
| TABLE 1 and 2 | 0 | 0.26 (ACUSOL ® 445G)¹ | 96.2 |
| Benchmark | 0 | 0 | 86.1 |
| laundry detergent | | | |
| package² | | | |

¹The liquid compartments contained 22 g total weight and the total weight of the agglomerated powder in the powder compartment was 1.75 g.
²The Benchmark laundry detergent package was used as sold.

### Example 3: Multi-Compartment Unit Dose Laundry Detergent

Exemplary multi-compartment unit dose laundry detergent compositions of the present invention were prepared using the liquid compositions shown in TABLE 4 and the solid composition of TABLE 2. The formulation for the liquid composition contains an anti-redeposition agent such as ALCOSPERSE® 747 (AkzoNobel, Chattanooga, Tenn.), ACUSOL® 445N (Dow Chemical Company, Midland, Mich.), or DEQUEST SPE-1202 (Italmatch, Genova, Italy). Detergent formulations were prepared as follows:

TABLE 4
Liquid composition formulations

| Component | 3 | 4 | 5 | 6 | 7 | 8 | 9 |
|---|---|---|---|---|---|---|---|
| C₁₂-C₁₅ alcohol | 20.0000 | 20.0000 | 20.0000 | 20.0000 | 20.0000 | 20.0000 | 20.0000 |
| ethoxylate 7EO | | | | | | | |
| hexylene glycol | 29.0364 | 28.5364 | 28.0364 | 27.5364 | 27.0364 | 27.5364 | 27.0364 |
| glycerin | 5.0000 | 5.0000 | 5.0000 | 5.0000 | 5.0000 | 5.0000 | 5.0000 |
| monoethanolamine | 1.7000 | 1.7000 | 1.7000 | 1.7000 | 1.7000 | 1.7000 | 1.7000 |
| deionized water | 6.1200 | 6.1200 | 6.1200 | 6.1200 | 6.1200 | 6.1200 | 6.1200 |
| sodium sulfite | 0.1000 | 0.1000 | 0.1000 | 0.1000 | 0.1000 | 0.1000 | 0.1000 |
| linear alkyl benzene | 5.0000 | 5.0000 | 5.0000 | 5.0000 | 5.0000 | 5.0000 | 5.0000 |
| sulfonic acid (LAS) | | | | | | | |
| coconut oil fatty acid | 5.0000 | 5.0000 | 5.0000 | 5.0000 | 5.0000 | 5.0000 | 5.0000 |
| sodium lauryl ether | 21.4286 | 21.4286 | 21.4286 | 21.4286 | 21.4286 | 21.4286 | 21.4286 |
| sulphate 2 EO | | | | | | | |
| Soil-releasing polymer | 2.5000 | 2.5000 | 2.5000 | 2.5000 | 2.5000 | 2.5000 | 2.5000 |
| ALCOSPERSE ® 747 | 0.0000 | 0.5000 | 1.0000 | 1.5000 | 2.0000 | 0.0000 | 0.0000 |
| ACUSOL ® 445N | 0.0000 | 0.0000 | 0.0000 | 0.0000 | 0.0000 | 1.5000 | 0.0000 |
| SPE 1202 | 0.0000 | 0.0000 | 0.0000 | 0.0000 | 0.0000 | 0.0000 | 2.0000 |
| Enzymes | 2.8000 | 2.8000 | 2.8000 | 2.8000 | 2.8000 | 2.8000 | 2.8000 |
| Fragrance | 1.0000 | 1.0000 | 1.0000 | 1.0000 | 1.0000 | 1.0000 | 1.0000 |
| Dyes | 0.3150 | 0.3150 | 0.3150 | 0.3150 | 0.3150 | 0.3150 | 0.3150 |
| Total | 100.000 | 100.000 | 100.000 | 100.000 | 100.000 | 100.000 | 100.000 |

### Example 4: Performance of Multi-Compartment Detergent Compositions

A five wash cycle test was conducted to measure the cleaning benefit of formulations of the invention shown in TABLE 4 compared to a leading competitive unit-dose laundry detergent. The anti-redeposition benefit is measure using the stain removal index (SRI)—a larger SRI indicates greater prevention of soil redeposition. The SRI was measured on cotton after wash cycle numbers 1, 3, and 5. TABLE 5 provides the liquid compositions used in two outer compartments and TABLE 2 provides the solid compositions used in the inner compartment in the multi-chamber unit doses.

TABLE 5 provides a comparison of the amount of anti-redeposition agent for 8 formulations versus SRI value after the 5th wash cycle. As shown in TABLE 5, the multi-chamber formulations of the invention gave a higher SRI than the competitive unit-dose laundry detergent. The inclusion of 0.11 g ALCOSPERSE® 747 (AkzoNobel, Chattanooga, Tenn.) in the liquid phase provided a SRI of 93.0 versus the SRI found for the Benchmark laundry detergent package of 89.0. Even more surprising was that the inclusion of the anti-redeposition agent ACUSOL® 445G (Dow Chemical Company, Midland, Mich.) in the powder phase provided a SRI of 97.8 compared to the SRI found for the Benchmark laundry detergent package of 89.0. Larger SRI values were observed after the first wash cycle with the performance gap increasing over the course of the 5 wash cycles.

TABLE 5
SRI values for multi-compartment unit
doses and competitive product.

| | Anti-redeposition | Anti-redeposition | |
|---|---|---|---|
| Liquid | agent in liquid | agent in powder | SRI |
| formula | chamber (g)¹ | chamber (g)² | value |
| 3 | 0 | 0.50 | 97.8 |
| | | (ACUSOL ® 445G) | |
| 4 | 0.11 (ALCOSPERSE ® 747) | 0 | 93.0 |
| 5 | 0.22 (ALCOSPERSE ® 747) | 0 | 94.1 |
| 6 | 0.33 (ALCOSPERSE ® 747) | 0 | 94.5 |
| 7 | 0.44 (ALCOSPERSE ® 747) | 0 | 95.1 |
| 8 | 0.33 (ALCOSPERSE ® 747) | 0 | 90.5 |
| 9 | 0.44 (SPE-1202) | 0 | 92.0 |
| Benchmark | 0 | 0 | 89.0 |
| liquid | | | |
| laundry | | | |
| package³ | | | |

¹The two liquid chambers contained 22 g total weight except for the Benchmark liquid laundry package.
²The powder chambers were adjusted to a weight of 1.5 g total using sodium citrate.
³The Benchmark laundry detergent package was used as sold.

### Example 5: Multi-Compartment Unit Dose Laundry Detergent

Exemplary multi-compartment unit dose laundry detergent compositions of the present invention were prepared using the liquid compositions shown in TABLE 6. The formulation for the liquid composition contains an anti-redeposition agent such as ALCOSPERSE® 747 (AkzoNobel, Chattanooga, Tenn.). Detergent formulations were prepared as follows:

TABLE 6
Liquid composition formulations.

| Component | 1 | 2 | 3 | 4 | 5 | 6 | 7 | 8 | 9 |
|---|---|---|---|---|---|---|---|---|---|
| C₁₂-C₁₅ alcohol | 20.0000 | 20.0000 | 20.0000 | 20.0000 | 20.0000 | 20.0000 | 20.0000 | 20.0000 | 20.0000 |
| ethoxylate 7 EO | | | | | | | | | |
| hexylene glycol | 28.9964 | 28.9964 | 28.9964 | 28.4964 | 27.9964 | 27.4964 | 27.0364 | 27.0364 | 0.0000 |
| propylene glycol | 0.0000 | 0.0000 | 0.0000 | 0.0000 | 0.0000 | 0.0000 | 0.0000 | 0.0000 | 16.0950 |
| glycerin | 5.0000 | 5.0000 | 5.0000 | 5.0000 | 5.0000 | 5.0000 | 5.0000 | 5.0000 | 5.0000 |
| monoethanolamine | 1.7000 | 1.7000 | 1.7000 | 1.7000 | 1.7000 | 1.7000 | 1.7000 | 1.7000 | 3.6000 |
| deionized water | 6.1200 | 6.1200 | 6.1200 | 6.1200 | 6.1200 | 6.1200 | 6.1200 | 6.1200 | 5.0000 |
| sodium sulfite | 0.1000 | 0.1000 | 0.1000 | 0.1000 | 0.1000 | 0.1000 | 0.1000 | 0.1000 | 0.0000 |
| linear alkyl benzene | 5.0000 | 5.0000 | 5.0000 | 5.0000 | 5.0000 | 5.0000 | 5.0000 | 5.0000 | 13.4000 |
| sulfonic acid (LAS) | | | | | | | | | |
| coconut oil fatty acid | 5.0000 | 5.0000 | 5.0000 | 5.0000 | 5.0000 | 5.0000 | 5.0000 | 5.0000 | 4.0000 |
| sodium lauryl ether | 21.4286 | 21.4286 | 21.4286 | 21.4286 | 21.4286 | 21.4286 | 21.4286 | 21.4286 | 0.0000 |
| sulfate 2-EO | | | | | | | | | |
| alkyl ether sulfate (AES) | 0.0000 | 0.0000 | 0.0000 | 0.0000 | 0.0000 | 0.0000 | 0.0000 | 0.0000 | 26.0000 |
| Bittering agent | 0.0400 | 0.0400 | 0.0400 | 0.0400 | 0.0400 | 0.0400 | 0.0400 | 0.4000 | 0.0400 |
| Soil-releasing polymer | 2.5000 | 2.5000 | 2.5000 | 2.5000 | 2.5000 | 2.5000 | 2.5000 | 2.5000 | 2.5000 |
| ALCOSPERSE ® 747 | 0.0000 | 0.0000 | 0.0000 | 0.5000 | 2.0000 | 0.0000 | 0.0000 | 0.0000 | 0.0000 |
| Enzymes | 2.8000 | 2.8000 | 2.8000 | 2.8000 | 2.8000 | 2.8000 | 2.8000 | 2.8000 | 3.1000 |
| Fragrance | 1.0000 | 1.0000 | 1.0000 | 1.0000 | 1.0000 | 1.0000 | 1.0000 | 1.0000 | 1.0000 |
| Dyes | 0.3150 | 0.3150 | 0.3150 | 0.3150 | 0.3150 | 0.3150 | 0.3150 | 0.3150 | 0.3150 |
| Total | 100.000 | 100.000 | 100.000 | 100.000 | 100.000 | 100.000 | 100.000 | 100.000 | 100.000 |

### Example 6: Performance of Multi-Compartment Detergent Compositions

To illustrate the performance of the formulations of the invention, a six wash cycle test was performed to compare a leading competitive unit-dose laundry detergent (Benchmark laundry detergent package) with formulations of the invention containing the liquid compositions of TABLE 6. The anti-redeposition benefit was measured by the SRI a larger SRI indicates greater prevention of soil redeposition. The SRI was measured on cotton after each wash cycle. TABLE 6 provides the formulations of the liquid compartments in the multi-chamber compositions. The multi-chamber compartments contained two liquid compartments and one powder compartment.

TABLE 7 provides a comparison of the amount of anti-redeposition agent for 10 formulations versus SRI value after the 6th wash cycle. As shown in TABLE 6, the multi-chamber formulations of the invention gave a higher SRI than the competitive unit-dose laundry detergent. The inclusion of 0.11 g ALCOSPERSE® 747 (AkzoNobel, Chattanooga, Tenn.) in the liquid phase provided a SRI of 93.0 versus the SRI found for the Benchmark laundry detergent package of 89.0. Even more surprising was that the inclusion of the anti-redeposition agent ACUSOL® 445G (Dow Chemical Company, Midland, Mich.) in the powder phase provided a SRI of 97.8 compared to the SRI found for the Benchmark laundry detergent package of 89.0. Larger SRI values were observed after the first wash cycle with the performance gap increasing over the course of the 5 wash cycles.

TABLE 7
SRI values for multi-compartment unit doses.

| | Anti-redeposition | Anti-redeposition | |
|---|---|---|---|
| Liquid | agent in liquid | agent in powder | SRI |
| formula | chamber (g) | chamber (g) | value |
| 1 | 0 | 0.50 | 98.4 |
| | | (ACUSOL ® 445G)¹ | |
| 2 | 0 | 0.75 | 98.7 |
| | | (ACUSOL ® 445G)¹ | |
| 3 | 0 | 1.25 | 98.4 |
| | | (ACUSOL ® 445G)¹ | |
| 4 | 0.11 | 0² | 92.0 |
| | (ALCOSPERSE ® 747)² | | |
| 5 | 0.22 | 0² | 93.4 |
| | (ALCOSPERSE ® 747)² | | |
| 6 | 0.33 | 0² | 96.1 |
| | (ALCOSPERSE ® 747)² | | |
| 7 | 0² | 0² | 90.4 |
| 8 | 0³ | 0³ | 91.7 |
| 9 | 0⁴ | 0⁴ | 92.5 |
| Benchmark | 0 | 0 | 89.9 |
| liquid laundry | | | |
| package³ | | | |

¹The powder chamber was adjusted to a weight of 1.5 g total using sodium citrate.
²The powder chamber was adjusted to a weight of 2 using sodium citrate and 22 g dose in the liquid chamber.
³No sodium citrate in the powder chamber and a 22 g dose in the liquid chamber.
⁴No sodium citrate in the powder chamber and 24 g dose in the liquid chamber.
⁵The Benchmark liquid laundry package was used as sold.

### Example 7: Performance of Detergent Compositions Containing a Citrate

Flow Cell Testing Parameters:

### Stain Type: Grass

### Fabric Type: Cotton 460

Test Duration: 120 minutes (data is collected every 30 seconds)
Flow Rate: Approximately 3.4 liters/minute
Water Type: 120 ppm of Calcium and Magnesium Water (0 ppm of Chlorine—Tested prior to run)

### Forelight: 5%

### Background Light: 30%

Samples were run in triplicate with 3 stains per swatch for a total of 9 stains per sample.

Wash liquor composition (simulates front loader or high-efficiency washing machine):

No Citrate:
2.5 liters of 120 ppm calcium and magnesium water
4.58 grams of test formulation liquid (standard dose is approximately 22 grams of liquid per wash (i.e., 12 liter wash liquor)
1.25 grams of white vinegar (5% acidity)—to simulate an acidic secondary stain source in wash

Citrate:
2.5 liters of 120 ppm calcium and magnesium water
4.58 grams of test formulation liquid (standard dose is approximately 22 grams of liquid per wash (i.e., 12 liter wash liquor)
1.25 grams of white vinegar (5% acidity)—to simulate an acidic secondary stain source in wash
0.52 grams of trisodium citrate, anhydrous (standard dose is approximately 2.5 grams of liquid per wash (i.e., 12 liter wash liquor)

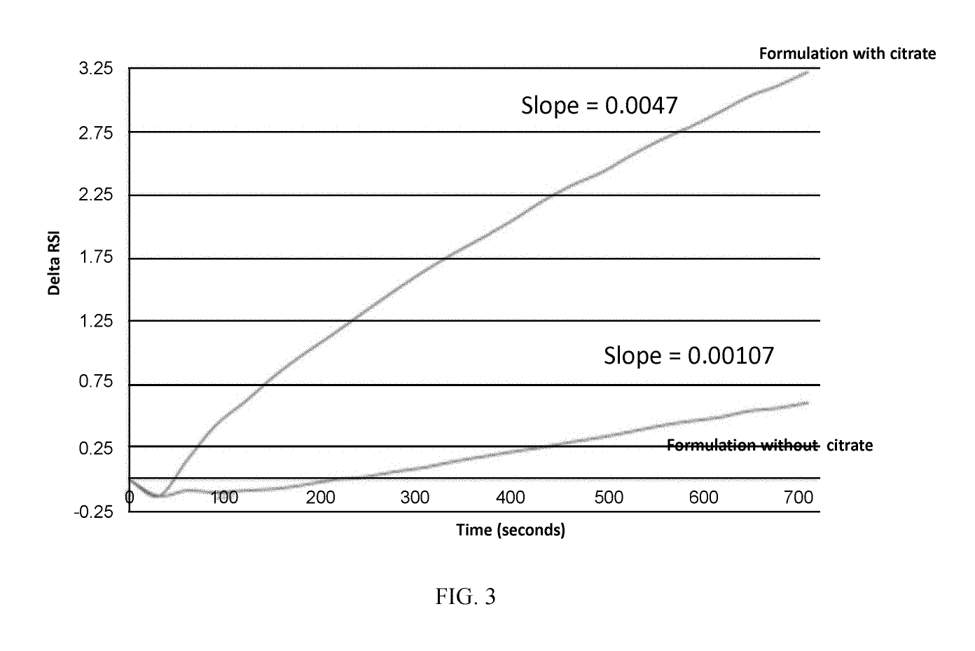

The RSI values for the formulations containing no citrate and the formulations containing citrate were calculated. A RSI value of 100 indicates that there is no stain remaining after the wash cycle whereas an RSI value of 0 indicates that the stain is completely unchanged after the wash cycle. As shown in FIG. 3, the slope of the change in RSI for the formulation containing no citrate (0.00107) versus the slope of the change in RSI for the formulation containing citrate (0.0047) was four times lower with a delta RSI of 0.6 versus 3.2 after running for 12 minutes (simulates one wash cycle). Therefore, the formulation containing citrate significantly outperformed the formulation containing no citrate on the cleaning rate of grass stains in the presence of vinegar.

Having now fully described this invention, it will be understood by those of ordinary skill in the art that the same can be performed within a wide and equivalent range of conditions, formulations and other parameters without affecting the scope of the invention or any embodiment thereof.

Other embodiments of the invention will be apparent to those skilled in the art from consideration of the specification and practice of the invention disclosed herein. It is intended that the specification and examples be considered as exemplary only, with a true scope and spirit of the invention being indicated by the following claim.

What is claimed is:

1. A unit dose laundry detergent composition comprising a multi-compartment container formed from a water-soluble polymer having at least two compartments, comprising:
a first compartment containing a solid composition;
a second compartment containing a liquid composition, wherein the liquid composition comprises between about 8% and about 25% water; and
at least one anti-redeposition agent,
wherein the first compartment is separate from and sealed off from the second compartment, and wherein the anti-redeposition agent is selected from the group consisting of an acrylic homopolymer and an acrylic/styrene copolymer.

2. The unit dose composition of claim 1, wherein the weight ratio of the solid composition to the liquid composition is between about 1:5 to about 1:30.

3. The unit dose composition of claim 1, comprising three compartments; wherein one compartment contains a solid composition and two compartments contain liquid compositions.

4. The unit dose composition of claim 1, wherein the at least one anti-redeposition agent is an acrylic acid homopolymer.

5. The unit dose composition of claim 1, wherein the at least one anti-redeposition agent is an acrylic homopolymer having an average molecular weight of between 3,000 and 5,000.

6. The unit dose composition of claim 1, wherein the at least one anti-redeposition agent is an acrylic/styrene copolymer having an average molecular weight of between 2,000 and 4,000.

7. The unit dose composition of claim 1, wherein the unit dose composition comprises at least one surfactant; wherein the at least one surfactant is selected from the group consisting of an anionic surfactant, a nonionic surfactant, a zwitterionic surfactant, an ampholytic surfactant, and a cationic surfactant.

8. The unit dose composition of claim 7, wherein the at least one surfactant is in the liquid composition.

9. The unit dose composition of claim 1, wherein the solid composition comprises a detergency builder.

10. The unit dose composition of claim 9, wherein the detergency builder is coated with a moisture-absorbing compound.

11. The unit dose composition of claim 10, wherein the moisture-absorbing compound is sprayed onto the solid composition.

12. The unit dose composition of claim 1, wherein the liquid composition comprises one or more components selected from the group consisting of a detergency builder, a biocidal agent, a foam controlling agent, an enzyme, a perfume, a dye, a pH buffering agent, an anti-redeposition agent, an optical brightener, a surfactant, a water-softening agent, a bleach, a solubilizer, or a stain-removing polymer.

13. The unit dose composition of claim 1, wherein the solid composition comprises one or more components selected from the group consisting of a detergency builder, a biocidal agent, a foam controlling agent, an enzyme, a perfume, a dye, a pH buffering agent, an anti-redeposition agent, an optical brightener, a surfactant, a water-softening agent, a bleach, a solubilizer, or a stain-removing polymer.

14. The unit dose composition of claim 1, wherein the solid composition comprises an anti-redeposition agent and sodium carbonate and wherein the liquid composition comprises a linear alkyl benzene sulfonate, a diol, an ethanolamine, and an ethoxylated alcohol.

15. The unit dose composition of claim 1, wherein the solid composition comprises sodium citrate and wherein the liquid composition comprises an anti-redeposition agent, a linear alkyl benzene sulfonate, a diol, an ethanolamine, and an ethoxylated alcohol.

16. The unit dose composition of claim 14, wherein the solid composition comprises by weight between about 5% and about 20% of an anti-redeposition agent and wherein the liquid composition comprises by weight between about 5% to about 20% of a linear alkyl benzene sulfonate, between about 5% to about 20% of a diol, between about 2% to about 10% of an ethanolamine, and between about 20% and about 25% of an ethoxylated alcohol.

17. The unit dose composition of claim 15, wherein the liquid composition comprises by weight between about 1% to about 5% of an anti-redeposition agent, between about 5% to about 20% of a linear alkyl benzene sulfonate, between about 5% to about 20% of a diol, between about 2% to about 10% of an ethanolamine, and between about 20% and about 25% of a ethoxylated alcohol.

18. A method of removing soils from soiled fabrics, comprising:
(a) placing the soiled fabrics into a chamber of an automatic fabric-laundering machine;
(b) placing at least one of the unit dose compositions of any one of claims 1-28 into the fabric-laundering machine; and
(c) introducing water into the chamber of the fabric-laundering machine and washing the fabrics in an aqueous environment in the fabric-laundering machine under conditions favoring release of components of the unit dose composition into the chamber of the fabric-laundering machine such that the components of the unit dose composition contact the fabrics and remove the soils from the fabrics.

19. The method of claim 18, wherein the unit dose composition is placed in the chamber of the fabric-laundering machine prior to introducing water into the chamber of the fabric-laundering machine.

20. The method of claim 18, wherein the unit dose composition is placed into the chamber of the fabric-laundering machine after introducing water into the chamber of the fabric-laundering machine.
